(19) United States
(12) Patent Application Publication
(10) Pub. No.: US 2006/0238581 A1
(43) Pub. Date: Oct. 26, 2006

(54) Ink-feeding device

(76) Inventors: Hisashi Yoshimura, Nara-shi (JP); Naozumi Ueno, Ikoma-shi (JP); Hirokazu Nakamura, Nara-shi (JP)

Correspondence Address: NIXON & VANDERHYE, PC, 901 NORTH GLEBE ROAD, 11TH FLOOR, ARLINGTON, VA, 22203, US

(21) Appl. No.: 10/550,275

(22) PCT Filed: Mar. 23, 2004
(86) PCT No.: PCT/JP04/03986

§ 371 Date: Jun. 26, 2006

(30) Foreign Application Priority Data
Mar. 28, 2003 (JP) 2003-092413
Jul. 30, 2003 (JP) 2003-204011

(51) Int. Cl. B41J 2/175

(52) U.S. Cl. 347/85

(57) ABSTRACT

An ink supply device includes an ink tank for containing ink inside and a tank holder for holding the ink tank in a detachable manner. The tank holder includes a control tank, a circulation needle, and an air supply needle. The control tank allows the ink and air to circulate between the control tank and the ink tank so that the internal pressure of the ink tank attached has a predetermined value.

### TECHNICAL FIELD

The present invention relates to an ink supply device containing ink that is to be provided to an inkjet printer and the like used for a facsimile machine, a copying machine, an OA (Office Automation) equipment printer and the like.

### BACKGROUND ART

Printing using an inkjet printing system is favorably used in a facsimile machine, a copying machine, an OA equipment printer and the like. This is because (i) relatively less noise is produced by the printing, and (ii) printing on standard paper is readily; facilitated in the inkjet printing system.

In an inkjet printer employing the system mentioned above as a device for performing image formation, a carriage including an ink head ejects ink while scanning back and forth in a direction perpendicular with respect to a direction in which recording medium is transferred. Generally this makes it possible to perform image formation.

Such an inkjet printer includes an ink tank for containing the ink that is to be ejected.

Conventionally, the ink tank has filling an inside there of a porous absorbent material so as to be able to absorb an internal pressure change due to a change in an amount of ink remaining inside the ink tank. Such an ink tank containing ink in a porous absorbent material is known (For example, refer to Japanese Unexamined Patent Publication No. 229133/1993 (Tokukaihei 5-229133, published on Sep. 7, 1993)(Hereinafter, denoted as Patent Document 1)).

Alternately, an ink tank may include a main ink chamber and a sub ink chamber so as to be able to absorb an internal pressure change due to an external environmental change (surrounding environmental change) such as a temperature change, an air pressure change, and the like. The main ink chamber contains the ink. The sub ink chamber communicates with the main ink chamber via a communicating opening and also has an opening communicating with the atmosphere on an upper side. In this sub ink chamber, an absorbent member is inserted. The sub chamber is filled with the ink in an amount that can be soaked up into by absorbent member. This makes it possible to control a negative pressure inside the main ink chamber (For example, refer to Japanese Unexamined Patent Publication No. 52405/1995 (Tokukaihei 7-52405 (published on Feb. 28, 1995) (Hereinafter, denoted as Patent Document 2)).

There is also known an ink cartridge having a connecting part for accepting insertion of an ink supply needle-like member for supplying the ink to a recording head. In such an ink cartridge, there are (i) a pouch-shaped ink storage body for storing the ink, and (ii) a waste ink collecting body for keeping the ink that is not used for recording but collected. The ink storage body and the waste ink collecting body can be replaced with respect to a casing for holding the ink storage body and the waste ink collecting body. In this ink cartridge, a cap member, to which a hollow needle for supplying the ink is inserted, is connected to the ink storage body by a tube and the like (Refer to Japanese Unexamined Patent Publication No. 2001-353882 (published on Dec. 25, 2001) (Hereinafter, denoted as Patent Document 3)).

There is further known an ink tank including pouch-shaped alleviation means communicating with the atmosphere in order to alleviate an increase in the internal pressure due to a volume expansion of air inside the tank caused by an environmental change (Refer to Japanese Unexamined Patent Publication No. 314709/1995 (Tokukaihei 7-314709) (published on Dec. 5, 1995) (Hereinafter, denoted as Patent Document 4)).

Furthermore, an ink tank can alternatively include a lever that changes shape so as to move a diaphragm. The diaphragm is moved so as to decrease a volume of an air chamber when a temperature of the ink tank exceeds a predetermined temperature due to the environmental change (Refer to Japanese Unexamined Patent Publication No. 337877/1998 (Tokukaihei 10-337877) (published on Dec. 22, 1998) (Hereinafter, denoted as Patent Document 5)).

However, according to the structure disclosed in Patent Documents 1 and 2, a porous material and the like, and/or an absorbent member (absorbent material) are provided inside the ink tank. These absorbent materials keep the ink soaked up.

This prevents the ink soaked up in the absorbent material from being used completely. Accordingly, ink utilization efficiency (ink amount that can be supplied/ink tank capacity) with respect to a capacity of the ink tank becomes low. Namely, the capacity of the ink tank cannot be utilized efficiently.

In the structure described in Patent Document 2, although the ink tank includes the main ink chamber and the sub ink chamber, replacement of each chamber is not taken into consideration. Accordingly, despite ink being left over in the porous material of the sub ink chamber, the whole ink tank needs to be replaced when the ink in the main ink chamber runs out. Moreover, when only the main ink chamber is arranged to have a large capacity so as to minify the ink left over, the ink pushed out from the main ink chamber due to a temperature change after the tank is installed cannot be absorbed into the porous body completely. Since this leads to an occurrence of ink leakage, there is an upper limit to increasing the capacity and efficiency of such an ink tank.

Moreover, in the case where the absorbent material is provided, when the ink flows in the absorbent material the ink is subjected to viscous resistance. In this case, a pressure (ink supply pressure) for pushing the ink out from the ink supply device changes depending on an amount of ink remaining. Namely, pressure loss occurs due to the absorbent material.

This makes consistent ink supply impossible. Accordingly, when a large amount of ink is supplied in high-speed printing and the like, an ability to supply an appropriate amount of ink at a proper time is deteriorated.

Further, in the structure described in Patent Document 3, the pouch-shaped ink storage body is contained in the casing. Accordingly, the capacity of the casing cannot be utilized to its fullest extent.

In the structure described in Patent Document 4, because the pouch-shaped alleviation means communicating with the atmosphere is contained in the ink tank, the capacity of the ink tank cannot be utilized efficiently.

In the structure described in Patent Document 5, the volume of the air chamber changes in response to only a temperature change. Accordingly, the volume cannot respond to an air pressure change, air bubble occurrence, air bubble inflow, and the like.

### DISCLOSURE OF INVENTION

The present invention is attained in view of the problems mentioned above. An object of the invention is to provide an ink supply device (i) that can absorb a pressure change inside the ink tank, (ii) that is capable of having an increased capacity, as well as (iii) being able to provide a consistent supply of ink. A further object of the present invention is aimed at efficiently utilizing the ink stored in the ink tank.

In order to achieve the object mentioned above, according to the present invention, in an ink supply device, which includes an ink tank for containing ink therein and a tank holder for holding the ink tank in a detachable manner, the tank holder includes pressure control means (for example, a circulation needle, an air supply needle, a pressure control needle, a pressure control tank, and the like) for allowing the ink and air to circulate between the tank holder and the ink tank so that an internal pressure of the attached ink tank has a predetermined value.

Namely, it is preferable that, in the ink supply device, a part (for example, one end of the circulation needle, the air supply needle, or the pressure control needle) of the pressure control means is inserted into the ink, tank when the ink tank is attached to the tank holder.

According to the structure above, the tank holder including the pressure control means and the ink tank are arranged to be detachable.

Accordingly, for example, the pressure control means includes a pressure control chamber capable of containing the ink and the air, which circulate between the tank holder and the ink tank. In this case, even when the ink tank is replaced in a state in which (i) the ink inside the ink tank is completely consumed but (ii) there is still ink inside the pressure control chamber of the pressure control means, the ink inside the pressure control chamber can still be utilized with an ink tank attached as a replacement. This makes it possible to efficiently use the ink by eliminating ink wastage.

Moreover, even when the pressure inside the ink tank changes along with (i) consumption of ink and (ii) a change in the surrounding environment (temperature), the pressure control means can control the pressure inside the ink tank through the circulation of the ink and the air. Namely, the pressure change inside the ink tank can be absorbed.

Further, by arranging the pressure control means so as to be detachable with respect to the ink tank, an absorbent material (for example, a porous body), which is for absorbing the pressure change so as to effect a negative pressure inside the ink tank, does not need to be included inside the ink tank.

Ordinarily, when the ink flows inside the absorbent material in the ink tank provided with the absorbent material, the ink is subjected to viscous resistance. In this case, the pressure (ink supply pressure) for ejecting the ink from the ink supply device changes depending on an amount of ink remaining. Namely, pressure loss occurs due to the absorbent material.

However, because the ink tank of the present invention does not include the absorbent material, such pressure change does not occur. Accordingly, the ink can be consistently supplied. Moreover, the ink tank is not discarded with ink remaining in an absorbent material. Accordingly, more efficient ink utilization is possible.

According to the present invention, in order to achieve the object, an ink supply device, which includes an ink tank for containing at least ink therein, includes capacity changing means for changing a capacity of the ink tank, according to a change in a state of a content inside the ink tank due to an environmental change outside the ink tank.

According to the structure, the capacity of the ink tank can be changed by the capacity changing means, according to a change in the state of the content inside the ink tank due to an environmental change outside the ink tank.

Here, when the ink supply device is attached to a printing device such as an inkjet printer and used, the state of the content in the ink tank changes due to the environmental change (for example, temperature change and air pressure change) outside the ink tank. The pressure inside the ink tank always changes due to such changes in the state of the content. Accordingly, in the ink supply device that does not include the capacity changing means, ink leakage occurs when the pressure change inside the ink tank becomes large.

However, as mentioned above, in the present invention, the capacity of the ink tank can be changed by the capacity changing means according to the change in the state of the content. Namely, when, for example, the pressure of the content such as the ink and the air increases due to a surrounding temperature change, the capacity of the ink tank can be increased. When the pressure of the content decreases, the capacity of the ink tank can be decreased. This makes it possible to control a pressure change inside the ink tank caused by the external environmental change.

Accordingly, by the capacity changing means, the internal pressure of the ink tank can be kept constant. Therefore, it becomes possible to provide an ink supply device capable of supplying the ink consistently.

According to the present invention, an ink supply device, which includes an ink tank for containing at least ink therein, includes pressure change control means for controlling a change in pressure, caused by consumption of the ink, inside the ink tank by supplying air to the inside of the ink tank from outside of the ink tank.

According to the structure mentioned above, the pressure change control means can control the pressure change, caused by the consumption of ink, inside the ink tank by supplying the air to the inside of the ink tank from outside of the ink tank.

When the ink in the ink tank is consumed in a case where the ink supply device is attached to a printing device such as an inkjet printer, the amount of ink in the ink tank decreases. Due to this decrease in the amount of ink, the pressure inside the ink tank always changes. Therefore, in the ink supply device that does not include a pressure change control means, the pressure change in the ink tank cannot be controlled. Accordingly, as the ink is consumed, a shortage in ink supply occurs due to an increase of a negative pressure in the tank. Conversely, when the ink supply device is on standby or left alone for a long time, air absorption and ink leakage from the nozzle occur due to a temperature change.

However, in the present invention, as mentioned above, the pressure change control means can control the pressure change, caused by the consumption of ink, inside the ink tank by supplying the air to the inside of the ink tank from the outside of the ink tank. Namely, by supplying the air into the ink tank as the ink is consumed, the pressure change inside the ink tank due to the consumption of ink and the pressure change due to the temperature change in a case where the ink supply device is left alone for a long time can be controlled.

Accordingly, by the pressure change control means, the internal pressure of the ink tank can be kept constant. Therefore, it becomes possible to provide an ink supply device capable of supplying the ink consistently.

For a fuller understanding of the nature and advantages of the invention, reference should be made to the ensuing detailed description taken in conjunction with the accompanying drawings.

### BRIEF DESCRIPTION OF DRAWINGS

FIG. 1 illustrates a structure of a main part of an ink supply device according to a first embodiment of the present invention.

FIG. 2 (a) is a diagram of a structure of an ink tank. FIG. 2 (b) is a diagram of a tank holder.

FIG. 3 schematically illustrates a structure of an inkjet printer using the ink supply device.

FIG. 4 illustrates a structure of a main part of the ink supply device according to another embodiment of the present invention.

FIG. 5 is a diagram of a structure of the ink supply device when felt is provided inside a pressure control tank.

FIG. 6 is a graph illustrating (i) an ink outflow caused by air volume expansion in the ink tank and (ii) an ink outflow caused by ink volume expansion in the ink tank, when a temperature in the ink tank rises from 5° C. to 55° C.

FIG. 7 is a graph illustrating an amount of ink remaining after the ink outflow from the ink tank, in a case where 80 cc of ink remaining in the ink tank is subjected to a repeated cycle of a 50° C. rise in temperature in the ink tank.

FIG. 8 is a graph illustrating a relation between the ink outflow caused by the ink volume expansion and a number of 50° C. temperature rise repetitions.

FIG. 9 is a sectional view schematically illustrating a structure of the ink supply device according to yet another embodiment of the present invention.

FIG. 10 is a graph illustrating a relation between pressure and volume.

FIG. 11 is a graph illustrating a relation between a radius of a mesh of a filter and a negative pressure in the ink tank.

FIG. 12 is a sectional view schematically illustrating a structure of another ink supply device, according to the yet another embodiment of the present invention.

FIG. 13 is a sectional view schematically illustrating a structure of yet another ink supply device according to the yet another embodiment of the present invention.

FIG. 14 is a sectional view of another structure of a mobile wall in the ink supply device.

### BEST MODE FOR CARRYING OUT THE INVENTION

### Embodiment 1

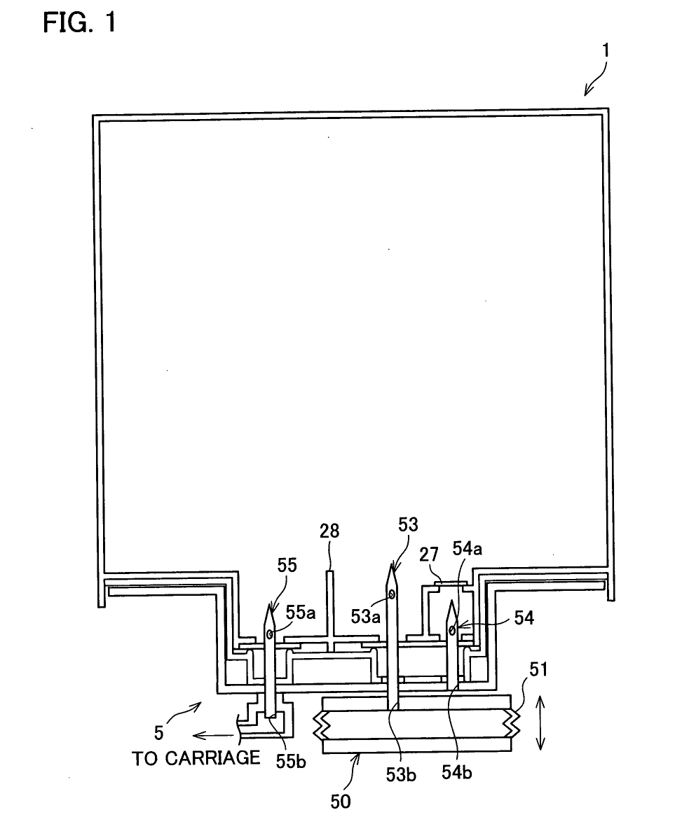

With reference to FIGS. 1 through 3, and FIGS. 6 through 8, a first embodiment of the present invention is explained as follows.

FIG. 1 illustrates a substantial structure of an ink supply device according to the first embodiment of the present invention. As illustrated in the diagram, the ink supply device includes an ink tank 1 containing ink and a tank holder 5 holding the ink tank 1. The ink tank 1 is arranged to be detachable with respect to the tank holder 5.

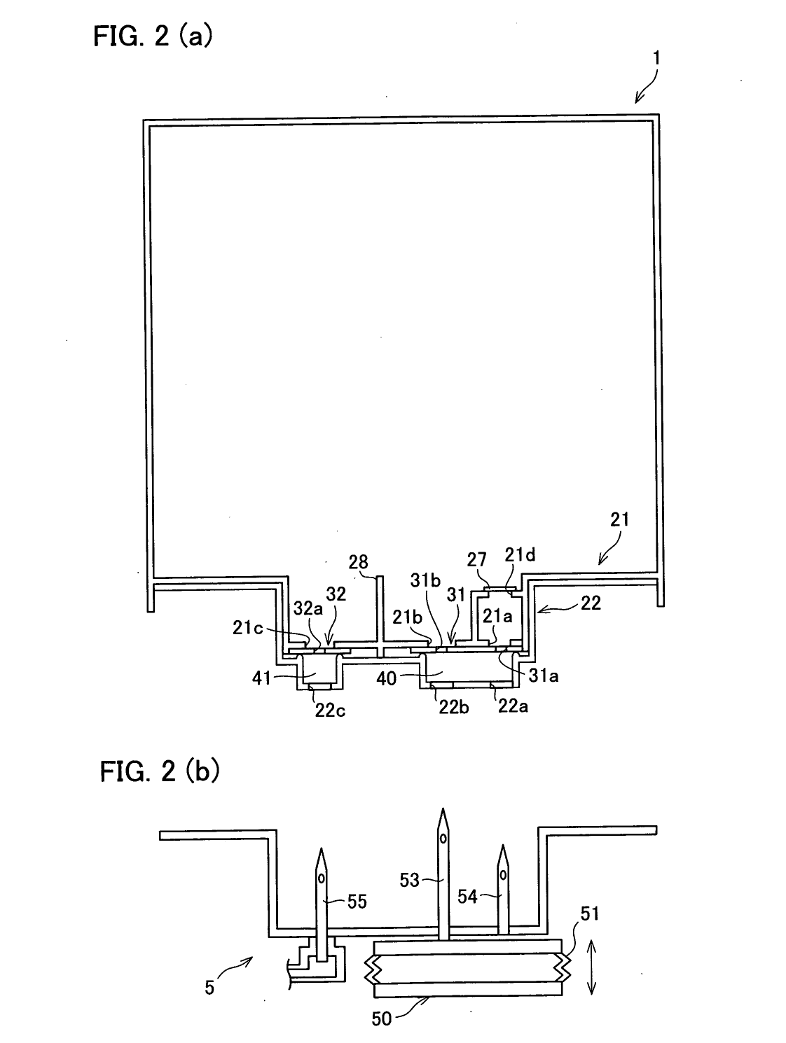

The tank holder 5, as illustrated in FIG. 2 (b), includes a control tank 50, a circulation needle 53, an air supply needle 54, and an ink supply needle (first ink supply means) 55. When the tank holder 5 is attached to the ink tank 1, the circulation needle 53, the air supply needle 54, and the ink supply needle 55 are inserted into the inside of the ink tank 1.

A side of the control tank 50 is made of a spring (biasing member) 51. The spring 51 biases top and bottom surfaces of the control tank 50 in a direction in which the capacity of the control tank 50 increases, namely, in a direction in which the spring 51 extends. Air and ink can circulate between the control tank 50 and the ink tank 1 via the circulation needle 53.

It is sufficient if the spring 51 is operable to bias the control tank 50 in a direction in which the capacity of the control tank 50 increases, and a material, shape, size, placement and the like of the spring 51 are not specifically limited. For example, only a part of the side surface may be made of a spring.

The circulation needle 53 is a hollow needle. An end on the ink tank 1 side is pointed. The circulation needle 53 has a circulation opening 53a near the end on the ink tank 1 side and a circulation opening 53b at an end on a control tank 50 side. The air and the ink is thus circulated between the circulation openings 53a and 53b.

The control tank 50 is connected with the circulation needle 53. Communication by the control tank 50 outside thereof is possible only via the circulation openings 53b and 53a of the circulation needle 53.

The control tank 50 and the circulation needle 53 are for absorbing a pressure change caused by a temperature change inside the ink tank 1.

The control tank 50 and the circulation needle 53 may be formed integrally.

The air supply needle 54 is a hollow needle. The air supply needle has a pointed end on the ink tank 1 side. The air supply needle 54 has an air communication opening 54a near the end on the ink tank 1 side and an air communication opening 54b at the other end on a control tank 50 side. The other end of the air supply needle 54 is opened to the outside by the air circulation opening 54b. Namely, the ink tank 1 communicates with the atmosphere via the air supply needle 54. The air supply needle 54 is for absorbing the pressure change caused by a change in an amount of ink remaining inside the ink tank 1.

The ink supply needle 55 is a hollow needle. The ink supply needle 55 has a pointed end on an ink tank 1 side. The ink supply needle 55 has a supply opening 55a near the end on the ink tank 1 side and a supply opening 55b at the other end on the control tank 50 side. The ink contained in the ink tank 1 is supplied to the outside (For example, an ink head and the like of a carriage, when the ink supply device is used in an inkjet printer.) of the ink tank 1 via the ink supply needle 55.

As illustrated in FIG. 2 (a), the side surface of the ink tank 1 on a side attached to the tank holder 5 is made of an inside wall 21 and an outside wall 22. The inside wall 21 includes opening sections 21a through 21d. The outside wall 22 includes opening sections 22a through 22d.

When the ink tank 1 is attached to the tank holder 5, the opening sections 21d, 21a and 22a correspond to a position into which the air supply needle 54 is inserted. The opening sections 21b, and 22b correspond to a position into which the circulation needle 53 is inserted. The opening sections 21c, and 22c correspond to a position into which the ink supply needle 55 is inserted.

A seal section 31, including opening sections 31b and 31a, is provided between the inside wall 21 and the outside wall 22, at the positions into which the needles 53 and 54 are inserted. A seal section 32, including an opening section 32a, is provided between the inside wall 21 and the outside wall 22, at the position into which the ink supply needle 55 is inserted. The seal sections 31 and 32 are arranged to prevent ink leakage from peripheries of the needles 53 through 55, when the needles 53 through 55 are inserted into the ink tank 1.

A mesh filter 27 is provided so as to cover the opening section 21d of the inside wall 21. The mesh filter 27 controls an internal pressure of the ink tank 1 so that the internal pressure is kept within a predetermined range. So long as a meniscus (an ink film) can be formed on the mesh filter 27 by the ink inside the ink tank 1, there is no limitation to a material, size and the like of the mesh filter 27. For example, the mesh filter 27 may be a braided metal mesh filter, a filter made of a knitted metal fiber or a knitted resin fiber, and the like.

Because the internal pressure of the ink tank 1 is negative, the meniscus on the ink filter 27 is concaved toward the inside of the ink tank 1.

The inside wall 21 includes an air protective barrier 28. The air protective barrier 28 stops air flow so that the air supplied inside the ink tank 1 from the circulation needle 53 and the air supply needle 54 is not supplied together with the ink through the supply opening 55a of the ink supply needle 55.

When the ink tank 1 as illustrated in FIG. 2 (a) is attached to the tank holder 5 as illustrated in FIG. 2 (b), the circulation needle 53, the air supply needle 54 and the ink supply needle 55 are inserted inside the ink tank 1. As the result, the ink supply device has a structure as illustrated in FIG. 1.

The control of the internal pressure of the ink tank 1 is explained as follows.

First, the internal pressure control, when the ink supply device is operating (when the ink tank 1 is used (the ink is consumed)), is explained.

An increase in a negative pressure inside the ink tank 1 accompanies the consumption of ink in the ink tank 1. When the negative pressure increases up to a predetermined value (a critical value), the meniscus formed by the ink on a surface of the mesh filter 27 breaks.

At this time, the ink tank 1 pulls in air via the mesh filter 27. This prevents the negative pressure of the ink tank 1 from becoming excessive. Accordingly, the internal pressure of the ink tank 1 can be controlled to within a predetermined range.

Specifically, when the ink is consumed, the air that comes in through the air supply needle 54 pushes against, due to increase in negative pressure inside the ink tank 1, a liquid surface of ink, which surface is formed on a mesh of the mesh filter 27. The air overcomes the surface tension of the liquid surface (the air brakes the meniscus). Then, the air passes through the liquid surface and becomes an air bubble. The pressure (the critical value) for generating this air bubble depends on a fineness of filtration of the mesh filter 27. However, by optimizing the fineness of the filtration, the internal pressure of the ink tank 1, that is, ink supply pressure can be kept constant. Moreover, the mesh filter 27 has a function for removing dust and the like larger than the fineness of the filtration.

In this way, the air supply needle 54 can control the internal pressure of the ink tank 1 when the ink supply device operates. Namely, the air supply needle 54 can absorb the pressure change caused by the change in the amount of ink remaining (consumption of ink).

Next, control of the internal pressure, when the temperature changes, is explained.

There is an occasion in which an environment surrounding the ink supply device changes according to a change in period of time, location of installation, or the like. In this case, the air volume inside the ink tank 1 changes, causing the internal pressure to also change.

For example, the air inside the ink tank 1 increases as the ink is consumed. In this and similar cases, a large internal pressure change results due to environmental changes. When the temperature inside the ink tank 1 changes from 5° C. to 55° C. under the condition in which the ink tank 1 contains, for example, 100 (cc) of air inside, the air volume becomes 100×(328/278)=118 (cc) according to Boyle-Charle's law. Accordingly, the volume changes by 18 (cc).

When the air volume inside the ink tank 1 changes in this way, the changed volume of the air or the ink is circulated between the ink tank 1 and the control tank 50 via the circulation needle 53. This makes it possible to absorb the pressure change, caused by the temperature change, inside the ink tank 1.

To be more specific, when the liquid level of the ink is found at a higher position (including a position at the same height) than the circulation opening 53a inside the ink tank 1, the ink and the air flows out to the control tank 50 via the circulation needle 53 from the inside of the ink tank 1 by the expansion of air (increase in the air volume inside the ink tank 1). Increasing and decreasing the capacity of the control tank 50 is possible by including the spring 51. Namely, the control tank 50 can contain the ink and the air that flow into the control tank 50 by extension of the spring 51.

When the liquid level of the ink is found at a lower position than the circulation opening 53a inside the ink tank 1, air flows out to the control tank 50 via the circulation needle 53 from the inside of the ink tank 1 by the expansion of air.

On the other hand, the ink tank 1 pulls, from inside the control tank 50, air or ink by an amount of a change in volume caused by air contraction (decrease in the air volume inside the ink tank 1). In other words, the air or the ink flows inside the ink tank 1 via the circulation needle 53.

Accordingly, even if there is a change, caused by a change in temperature, in air volume inside the ink tank 1 under a standby condition of the ink supply device, the volume change, that is, the pressure change inside the ink tank 1, can be absorbed by the circulation needle 53 and the control tank 50.

In this way, by including the control tank 50, the ink that has been pushed out of the ink tank 1 once also can be utilized. This makes it possible to improve the efficiency of ink utilization.

The tank holder 5 and the ink tank 1 are detachable. Accordingly, even if the ink tank 1, is replaced at a time when (i) the ink inside the ink tank 1 is consumed, but (ii) there still remains ink inside the control tank 50, the ink inside the control tank 50 can be utilized with an ink tank attached as a replacement. This makes it possible to utilize the ink efficiently by eliminating the ink wastage.

In spaces 40 and 41 formed respectively between (i) the seal section 31 as illustrated in FIG. 2 (a) and the outside wall 22, and (ii) the seal section 32 as illustrated in FIG. 2 (a) and the outside wall 22, a porous body made of a porous member (for example, batting material made of polyester fibers bundled in one direction, and the like) may be provided. This makes it possible to absorb the ink adhering to the needles 53 through 55 when the ink tank 1 is detached from the tank holder 5. This prevents ink from adhering to the user who detached the ink tank 1.

It is preferable that the ink supply needle 55 is inserted last in the order of the insertion of the needles 53 through 55 into the ink tank 1, when the ink tank 1 is attached to the tank holder 5.

For example, assume that the ink supply needle 55 is inserted first. In this case, when the circulation needle 53 and the air supply needle 54 are inserted, the pressure change occurs inside the ink tank 1. Accordingly, the air and the ink flow out of the ink supply needle 55.

However, by inserting the ink supply needle 55 last, the pressure change caused by the insertion of the ink supply needle 55 can be absorbed by the circulation needle 53 and the air supply needle 54. This prevents the air and the ink from being pushed out of the ink supply needle 55 into, for example, the ink supply tube (an ink supply channel). Accordingly, when an image is formed with the ink, deterioration in an image quality caused by evacuation of the air and ink accumulated in the ink supply tube can be prevented.

Moreover, it is preferable that the ink supply needle 55 is pulled out first in the order of the removal of the needles 53 through 55 from the ink tank 1 when the ink tank 1 is detached (separated) from the tank holder 5.

For example, assume that the ink supply needle 55 is pulled out last. In this case, when the circulation needle 53 and the air supply needle 54 are pulled out, a pressure change occurs inside the ink tank 1. Accordingly, for example, the air is pulled into the ink supply tube (ink supply channel) via the ink supply needle 55 from the end of the nozzle of the carriage.

However, by pulling out the ink supply needle 55 first, the pressure change caused by the pulling out of the ink supply needle 55 can be absorbed by the circulation needle 53 and the air supply needle 54. Accordingly, for example, the ink supply tube (the ink supply channel) can be prevented from drawing in air. Therefore, when an image is formed with the ink, a deterioration in an image quality caused by the evacuation of the air accumulated in the ink supply tube can be prevented.

In the ink supply device described above, only ink and air are contained inside the ink tank 1. Materials/substances other than the ink and the air (for example, a containing member, such as an ink absorber, an ink pouch or the like) are not contained inside the ink tank 1. When the ink flows inside a containing member under a condition in which such a containing member is provided, the ink is subjected to viscous resistance. In this case, when the ink flows out of the ink supply needle 55, a pressure (ink supply pressure) for expelling the ink changes depending on the amount of ink remaining. Namely, pressure loss occurs due to the containing member.

Accordingly, when ink is supplied, according to the present ink supply device, there is no pressure loss caused by the flow of ink in a containing member. Therefore, the ink can be supplied consistently. As a result, when a large amount of ink is supplied during high-speed printing and the like, an ability to supply an appropriate amount of ink at a proper time can be improved.

Further, the control tank 50 is provided near a bottom surface of the ink tank 1. This makes it possible to control the internal pressure by using the control tank 50 until the ink inside the ink tank 1 is used completely.

Moreover, by using the control tank 50, the internal pressure of the ink tank 1 can be controlled in accordance with a pressure substantially same as a pressure at the supply opening 55a that is an ink outflow opening. Accordingly, the ink supply pressure (a pressure necessary for the ink supply) can be controlled. Therefore, a consistent ink supply can be achieved.

When (i) the capacity of the ink tank 1 is Vt and (ii) the capacity of the control tank 50 is Vs, the relation between the capacities Vt and Vs satisfies 0.1≦Vs/Vr≦0.3.

In consideration of a withstand pressure of the nozzle of the ink head for ejecting the ink onto a recording medium, an acceptable value in the change of the ink supply pressure is substantially 2 kPa to 3 kPa. Moreover, if the temperature rise is 20° C. to 50° C., the change of the air volume inside the ink tank 1 is substantially 7% to 17%.

By having the capacities Vt and Vs that satisfy the relationship above, the control tank 50 does not become fully filled with ink. Accordingly, by circulating the ink and the air between the control tank 50 and the ink tank 1, control of the internal pressure of the ink tank 1 is possible. Namely, it is possible to keep the ink tank 1 at an appropriate negative pressure.

As mentioned above, the ink supply device of the present invention includes the ink tank 1 containing therein ink and the tank holder 5 holding the ink tank 1 in a detachable manner.

Moreover, in the ink supply device, the tank holder 5 includes pressure control means (in FIG. 1, the circulation needle 53 that makes it possible to circulate the ink and the air, the control tank 50, and the air supply needle 54 that makes it possible to circulate the air) for allowing the ink and the air to circulate between the tank holder 5 and the ink tank 1 so that the internal pressure of the attached ink tank 1 becomes a predetermined value.

Namely, in the ink supply device, the circulation needle 53 and the air supply needle 54 are inserted into the ink tank 1 when the ink tank 1 is attached to the tank holder 5.

The tank holder 5 and the ink tank 1 are arranged to be detachable by this.

Accordingly, for example, in an arrangement where the ink supply device includes, as the pressure control means, the control tank 50 that can contain the ink and the air circulating between the control tank 50 and the ink tank 1, even if the ink inside the ink tank 1 is consumed and replaced when ink still remains inside the control tank 50, this ink inside the control tank 50 can be utilized by with an new ink tank 1 attached as a replacement. This makes it possible to utilize the ink efficiently by eliminating ink wastage.

Even if the internal pressure of the ink tank 1 changes with the consumption of ink and changes in the surrounding environment (temperature), the internal pressure of the ink tank 1 can be controlled by the circulation of the ink and air via the circulation needle 53, the control tank 50, and the air supply needle 54. Namely, the pressure change inside the ink tank 1 can be absorbed.

Further, by arranging the circulation needle 53, the control tank 50, and the air supply needle 54 to be detachable with respect to the ink tank 1, an absorbent material (for example, porous body) does not need to be included inside the ink tank 1; the above absorbent material being for absorbing the pressure change by making the pressure inside the ink tank 1 negative.

Usually, when the ink flows in the absorbent material under the condition in which the absorbent material is provided, the ink is subjected to viscous resistance. In this case, the pressure for expelling the ink out from the ink supply device (the ink supply pressure) changes depending on the amount of ink remaining. Namely, the pressure loss occurs due to the absorbent material.

However, because the ink tank 1 does not include an absorbent material, such pressure change does not occur. Accordingly, consistent ink supply is possible.

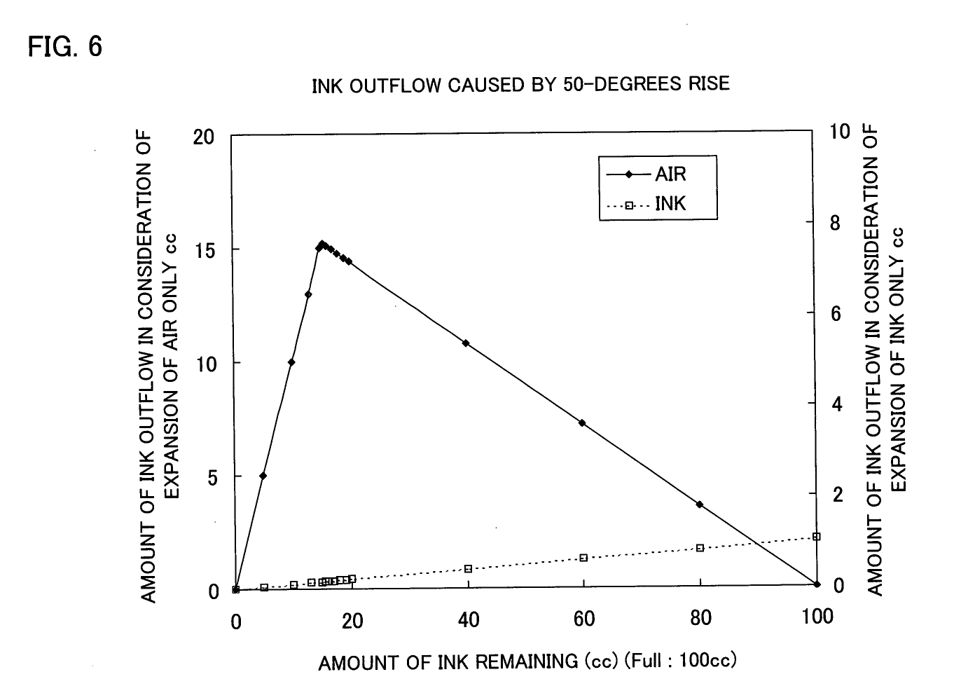

The amount of ink outflow due to the expansion of air volume inside the ink tank 1, and the amount of ink outflow due to the expansion of ink volume inside the ink tank 1, when the temperature inside the ink tank 1 rises from 5° C. to 55° C. (50° C. rise), are illustrated in FIG. 6. This clearly shows that the ink outflow due to the expansion of ink volume is substantially 1/15 of the ink outflow due to the air volume expansion.

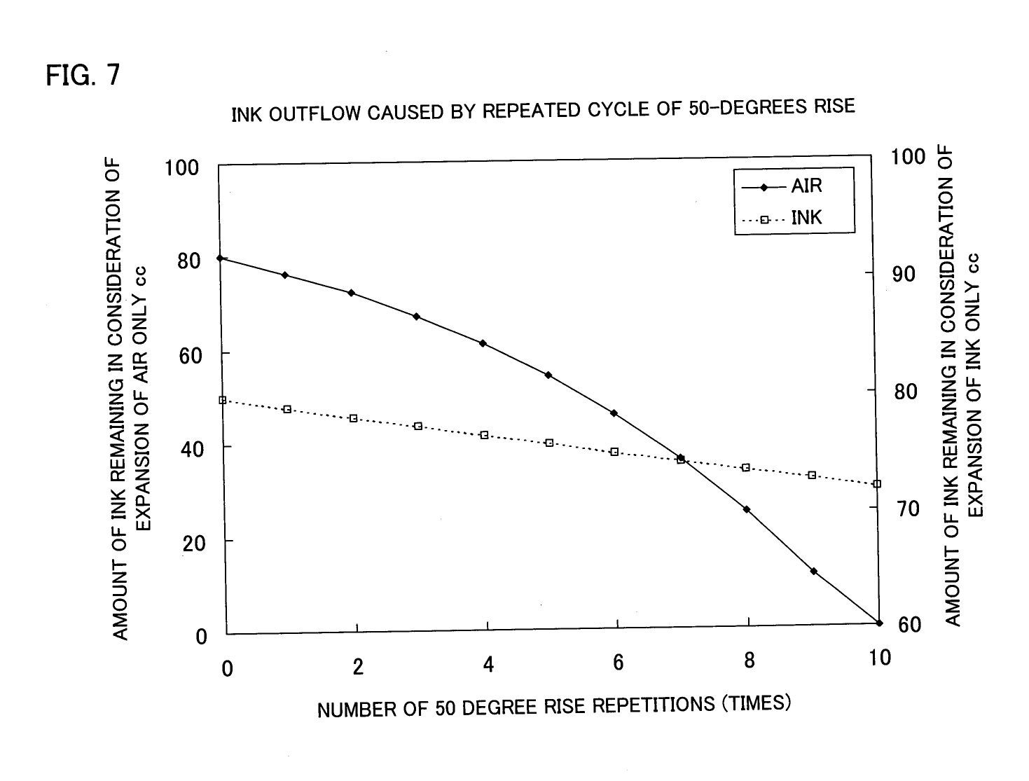

The amount of ink remaining after an outflow of the ink from the ink tank 1 is illustrated in FIG. 7, for a case where the amount of ink remaining inside the ink tank 1 is 80 cc (the amount of the air at this time is 20 cc) and the ink inside the ink tank is subjected to a repeated cycle of a 50° C. rise in temperature.

As illustrated in FIG. 7, even if the amount of the initial remaining ink is 80 cc, ten repetitions of the 50° C. rise in temperature cause 100% of the ink to flow out due to the expansion of air volume. Compared with this, the amount of ink outflow caused by the expansion of ink is smaller. As the result of the ten repetitions of the 50° C. rise in temperature, 72% of the ink remains and 8% of the ink flows out.

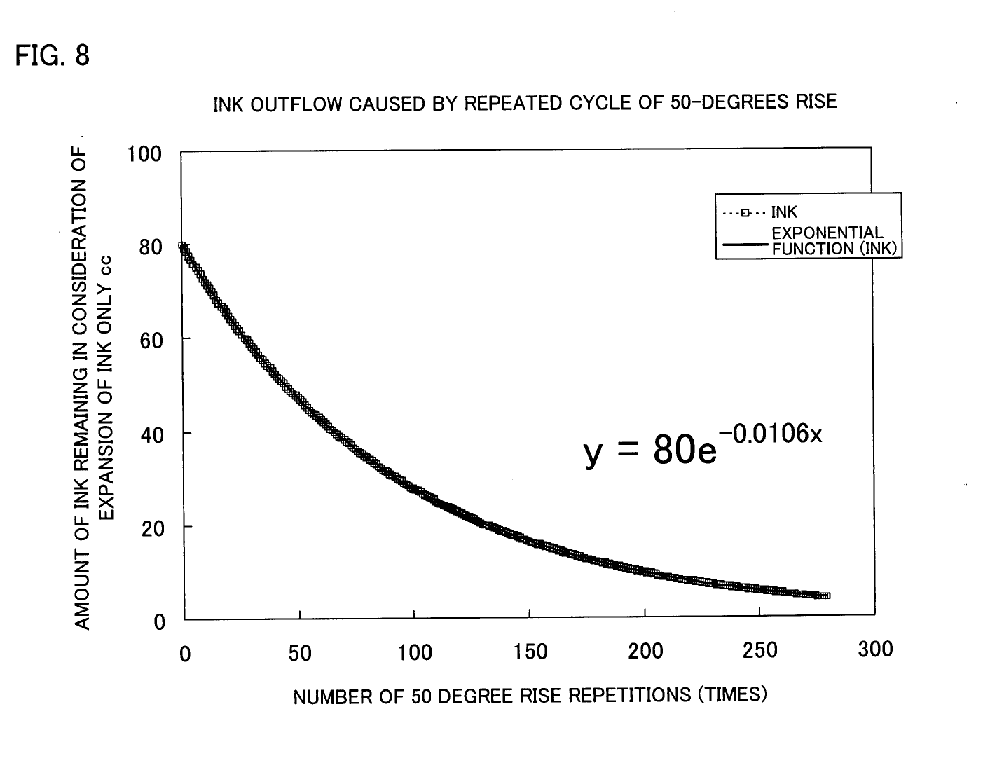

FIG. 8 illustrates a relationship between the ink outflow caused by the expansion of ink volume and a number of the 50° C. temperature rise repetitions. As illustrated in FIG. 8, when the amount (cc) of ink remaining=y, and the number of the 50° C. temperature rise repetitions=x, the relation becomes close to the following formula:
y=80e^{(-0.0106)} (1)
Namely, a time constant of the decrease in an amount of ink remaining due to the repetitions of the 50° C. rise in temperature is 100.

Assume that the ink tank 1 is full of ink under a condition that the capacity of the ink tank 1 is 100 cc. In this case, there is no air in the ink tank 1. Accordingly, when the temperature rises, only the ink outflow caused by the expansion of ink volume needs to be considered. For example, when the ink volume expansion rate is 0.21×10⁻³, the capacity of the ink tank 1=100 cc, and the temperature rise of the ink tank 1 (ΔT)=50° C., the expansion of ink volume is 1.05 cc.

Accordingly, even if (i) the ink tank 1 and the control tank 50 are detachable and (ii) a new ink tank 1 full of ink is attached to the tank holder 5, the outflow of the ink caused by the expansion of ink does not become a big problem.

The ink supply device can also absorb an internal pressure change of the ink tank 1 due to changes in the surrounding environment (temperature) by including the control tank 50 (pressure control chamber).

Even if the ink tank 1 is replaced at a time when (i) the ink inside the ink tank 1 is consumed, but (ii) there still remains ink inside the control tank 50, the ink inside the control tank 50 can be utilized with an ink tank attached as a replacement. This makes it possible to utilize the ink efficiently by eliminating the ink wastage.

The ink supply device includes the air supply needle 54 for supplying air inside the ink tank 1 from outside. This allows the ink tank 1 to communicate with the atmosphere when the ink tank 1 is attached. This makes it possible to absorb an internal pressure change, caused by the consumption of ink, in the ink tank 1.

Moreover, the air supply needle 54 is included in the tank holder 5, detachable with respect to the ink tank 1. This makes it possible to seal the ink tank 1 when the ink tank 1 is detached from the tank holder 5. Accordingly, leakage of ink from the ink tank 1 can be prevented.

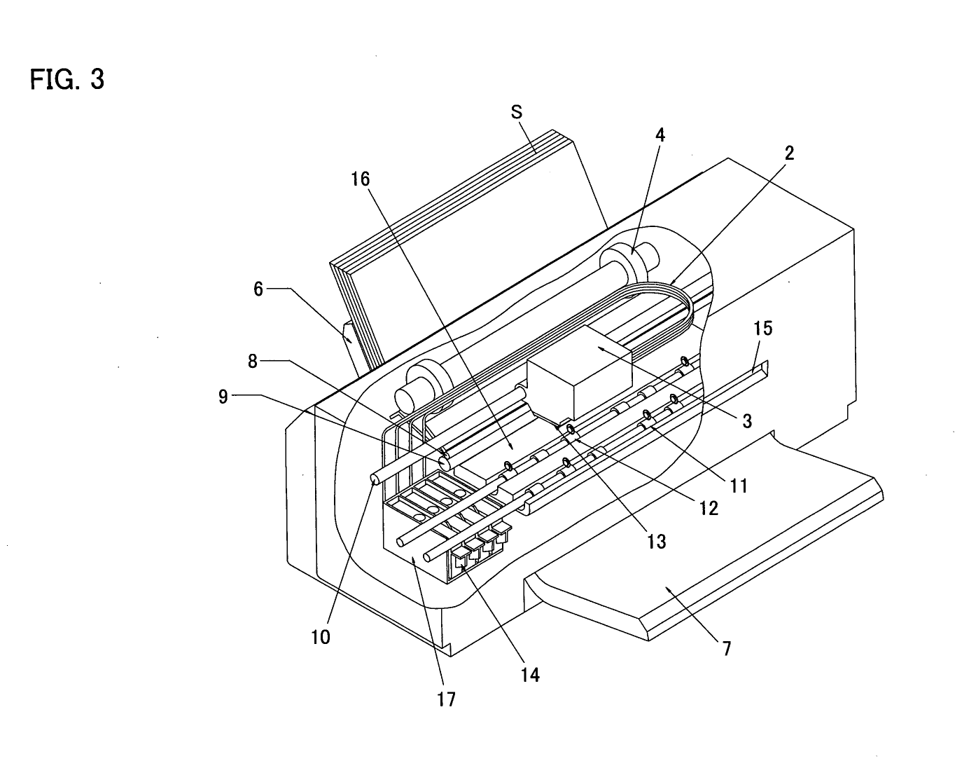

A structure in which the ink supply device as mentioned above is applied to an inkjet printer is explained as follows with reference to FIG. 3.

As illustrated in FIG. 3, the inkjet printer includes a paper supply section (paper supply device), a separating section, a transfer section, a printing section, and an output section.

The paper supply section feeds a sheet(s) (recording paper) S when printing is carried out. The paper supply section is made of a paper feed tray 6 and a pick-up roller 4. When the printing is not carried out, the paper supply section stores the sheet(s) S.

The separating section (not illustrated) supplies one sheet S, at a time, from the sheet(s) S fed from the paper supply section mentioned above to the printing section explained later. The separating section is made of a paper transfer roller and a separating device. At the separating device, friction between a pad section (a point of contact with the sheet S) and the sheet S is arranged to be larger than friction between the sheets S. Moreover, at the paper transfer roller, friction between the paper transfer roller and the sheet is arranged to be larger than (i) the friction between the pad section and the sheet S and (ii) the friction between the sheets S. Accordingly, even if two sheets S are sent to the separating section, the paper transfer roller separates these sheets S. Therefore, the paper transfer roller transfers only the upper sheet S.

The transfer section transfers the sheet S fed from the separating section one at a time into the printing section. The transfer section is made of a guide plate (not illustrated) and a pair of rollers (a hold-down roller 8 and a transfer roller 9). The pair of the rollers are members for adjusting the transfer of sheet S, when the sheet S is transferred between a printing head 13 explained later and a platen 16, so that the ink from the printing head 13 is ejected onto an appropriate position of the sheet S.

The printing section carries out printing on the sheet S fed by the pair of rollers of the transfer section. The printing section includes (i) the printing head 13, (ii) a carriage 3 including the printing head 13, (iii) a guide shaft 10 that is a member for guiding the carriage 3, (iv) an ink cartridge 14 for supplying the ink to the printing head 13, (v) the ink cartridge attachment section 17 for holding the ink cartridge, (vi) an ink supply tube 2 for supplying ink to the carriage from the ink cartridge 14, and (vii) a platen 16 constituting a platen for the sheet S when printing is carried out.

The output section outputs the sheet S, on which the printing has been carried out, outside of the inkjet printer. The output section includes output rollers 11 and 12, a paper output opening 15, and an output paper tray 7.

The ink tank 1 as illustrated in FIG. 1 explained above is provided to the ink cartridge 14. Moreover, the tank holder 5 as illustrated in FIG. 1 is a part of the ink cartridge attachment section 17.

The operation of the inkjet printer, when printing is performed, is explained as follows.

First, a printing request is given from a computer (not illustrated) and the like to the inkjet printer on the basis of image information. Then, the inkjet printer that has received the printing request transfers the paper S onto the paper feed tray 6 by the pick up roller 4.

Next, the transferred sheet S is passed through the separating section by the paper feed roller, and is transferred to the transfer section. The transfer section transfers the sheet S to a space between the printing head 13 and the platen 16 by the pair of the rollers.

At the printing section, the ink is ejected (discharged) from the nozzle of the printing head 13 onto the sheet S on the platen 16, in accordance with the image information. At this time, the sheet S stays temporarily on the platen 16. The carriage 3, which is ejecting the ink, scans one line in a main scanning direction. At this time, the carriage 3 is guided by the guide shaft 10. When the carriage 3 completes the scanning, the sheet S is moved on the platen 16 by a predetermined distance in a sub scanning direction. At the printing section, the printing of the entire sheet S is carried out by repetition of the process mentioned above in accordance with the image information.

The ink is supplied to the carriage 3 from the ink cartridge 14 via the ink supply tube 2. The ink supplied to the carriage 3 is ejected from the nozzle of the printing head 13.

Subsequently, the sheet S, on which the printing has been carried out, passes through an ink drying section and is outputted onto the output paper tray 7 from the paper output opening 15 by the output rollers 11 and 12. Then, the sheet S is provided to the user as printed material.

### Embodiment 2

Another embodiment of the present invention is explained with reference to FIGS. 1, 2, 4, and 5 as follows. In description of this embodiment of the present invention, elements having functions equivalent to elements in the embodiment 1 are denoted by the same reference numbers and explanations thereof are omitted.

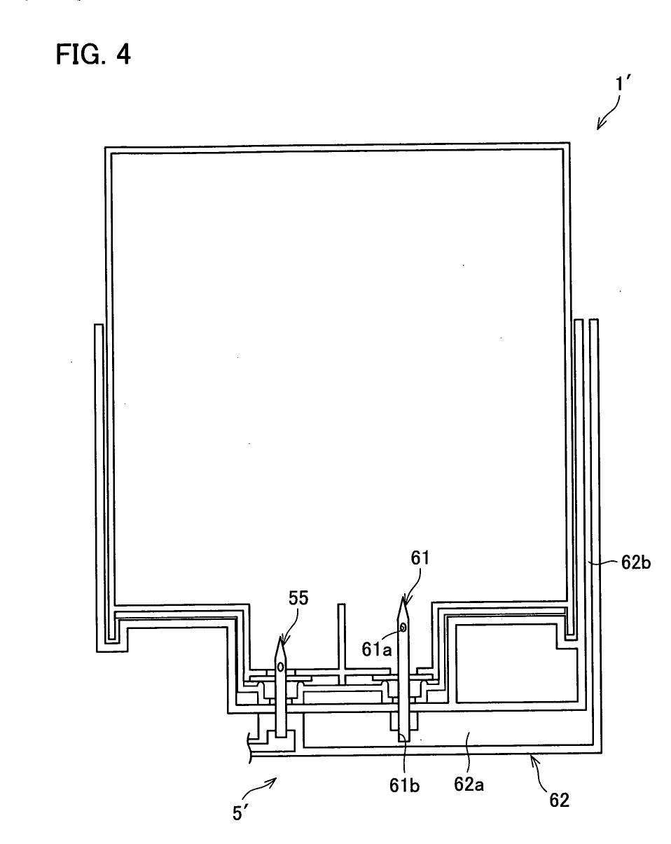

A structure of an ink supply device of the present embodiment is illustrated in FIG. 4. As illustrated in FIG. 4, this ink supply device includes an ink tank 1′ and a tank holder 5′. The ink tank 1′ is arranged to be detachable with respect to the tank holder 5′. This ink supply device has an arrangement (refer to FIG. 1 and FIG. 2) in which a circulation needle 53, an air supply needle 54, and a control tank 50 of an ink supply device in the first embodiment are formed integrally. Namely, the ink tank 1′ includes a pressure control needle 61 and a pressure control tank 62 instead of the circulation needle 53, the air supply needle 54, a mesh filter 27, and the control tank 50 of the ink tank 1.

Accordingly, the ink tank 1′ includes an opening section and a seal section for each of the ink supply needle 55 and the pressure control needle 61.

The ink tank 1′ and the pressure control tank 62 are in communication with each other by the pressure control needle 61. Air and ink can circulate between the ink tank 1′ and the pressure control tank 62.

The pressure control needle 61 is a hollow needle and an end thereof on an ink tank 1′ side is pointed. The pressure control needle 61 has a circulation opening 61a near an end on the ink tank 1′ side and a circulation opening 61b at another end on a pressure control tank 62 side.

The pressure control tank 62 includes a control chamber 62a that can store the air and the ink, and a control chamber 62a, namely, an air communicating channel 62b for causing the ink tank 1′ to communicate with the atmosphere. Namely, an internal pressure of the ink tank 1′ is always controlled to be at atmospheric pressure.

Control of the internal pressure, at the time when the ink supply device operates (when the ink tank 1′ is used (ink is consumed)), is explained here in below.

As the ink inside the ink tank 1′ is consumed, the internal pressure of the ink tank 1 changes. This causes the ink tank 1′ to pull in at least the air or the ink from the pressure control needle 61. In this way, the internal pressure of the ink tank 1′ is controlled so that atmospheric pressure is maintained. This makes it possible to absorb a pressure change caused by a change in an amount of ink remaining inside the ink tank 1′.

Next, a control of internal pressure, when a temperature changes, is explained.

When an air volume inside the ink tank 1′ changes, the air or the ink equivalent to the changed volume is arranged to circulate between the ink tank 1′ and the pressure control tank 62 via the pressure control needle 61. This makes it possible to absorb the pressure change caused by a temperature change inside the ink tank 1′.

Namely, when the air inside the ink tank 1′ expands, the ink and the air flow into the pressure control tank 62 from the ink tank 1′. This controls the internal pressure of the ink tank 1′ so that the internal pressure is maintained at atmospheric pressure.

Moreover, when the air inside the ink tank 1′ contracts, the ink and the air flow inside the ink tank 1′ from the pressure control tank 62. This controls the internal pressure of the ink tank 1′ so that the internal pressure is maintained at the atmospheric pressure.

In this way, the pressure control tank 62 can absorb (i) the pressure change caused by the change in temperature inside the ink tank 1′ and (ii) the pressure change when the ink supply device operates.

There is a case, in which the air or the ink flows into the ink tank 1′ from the pressure control tank 62 when the pressure changes, as mentioned above. In this case, the pressure control needle 61 in the pressure control tank 62 is arranged to be in a position such that the pressure control needle 61 can pull in the ink first, when the ink is stored at the bottom inside the control chamber 62.

According to this, when a level of ink in the ink tank 1′ becomes lower than the circulation opening 61a due to the consumption of ink, air flows into the pressure control tank 62 from the ink tank 1′. Conversely, ink flows into the ink tank 1′ from the control tank 62. Then, when the ink inside the pressure control tank 62 runs out, the internal pressure of the ink tank 1′ can be stabilized at atmospheric pressure by causing the air to flow into the ink tank 1′.

Accordingly, the ink can be completely consumed thereby eliminating the ink wastage.

Inside the pressure control tank 62, a porous body in which the ink has been absorbed beforehand may be included.

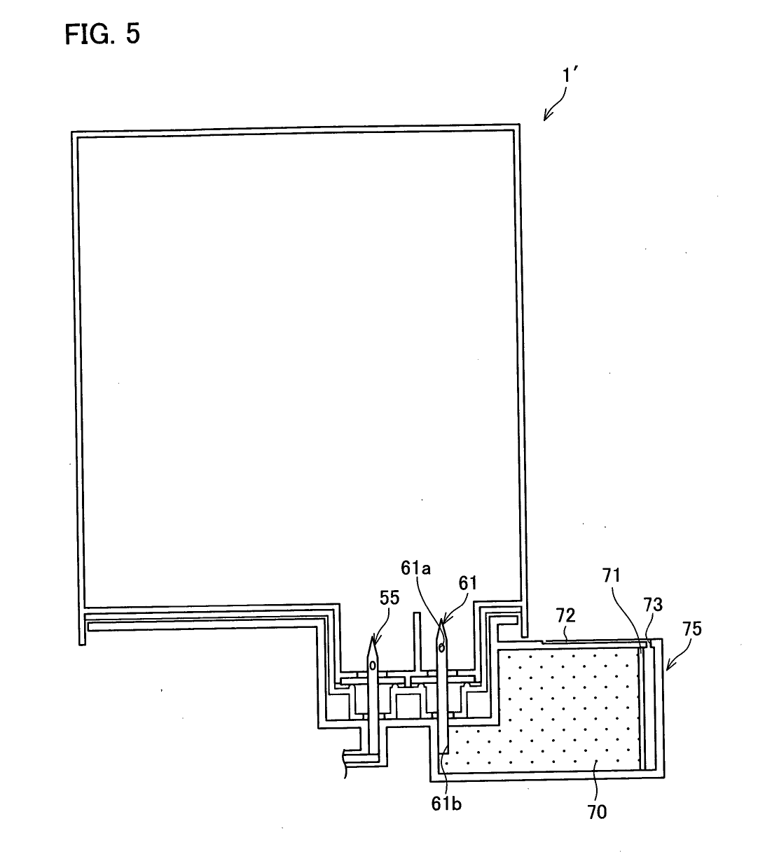

With reference to FIG. 5, a pressure control tank 75 including a porous body (an ink absorber) 70 is explained as follows.

The pressure control tank 75 includes the porous body 70 and a mesh filter (negative pressure control section) 71. The pressure control tank 75 communicates with the atmosphere through an opening section 73.

The ink is contained beforehand in the porous body 70. In a mesh of the mesh filter 71, a meniscus is formed by the ink.

When a negative pressure within the ink tank 1′ becomes large, the meniscus breaks. Then, air from the opening section 73 is supplied to the pressure control tank 75. The ink pushed by the supplied air is supplied to the ink tank 1′ from the pressure control tank 75 via the pressure control needle 61. The internal pressure of the ink tank 1′ is controlled by this. Namely, the pressure control tank 75 can absorb the pressure change inside the ink tank 1′.

Once the internal pressure of the ink tank 1′ is stabilized by the air supply after a meniscus on the mesh filter 71 has broken, the negative pressure decreases. At this time, the meniscus is reformed.

After the ink supplied to the ink tank 1′ from the pressure control tank 75 runs out, the internal pressure of the ink tank 1′ is controlled by the air inside the pressure control tank 75.

Moreover, even if the ink flows out into the pressure control tank 75 from the ink tank 1′ due to a change in temperature and the like, such ink is made to flow back inside the ink tank 1′ again by the internal pressure change of the ink tank 1′. This makes it possible to use the ink completely. Accordingly, the wastage of the ink can be eliminated.

The opening section 73 is sealed by a seal tape 72 before the opening section 73 is used. This prevents the ink inside the pressure control tank 75 from evaporating.

A structure, material, and the like of the porous body 70 and the mesh filter 71 are not specifically limited. Moreover, the mesh filter 71 is dispensable.

### Embodiment 3

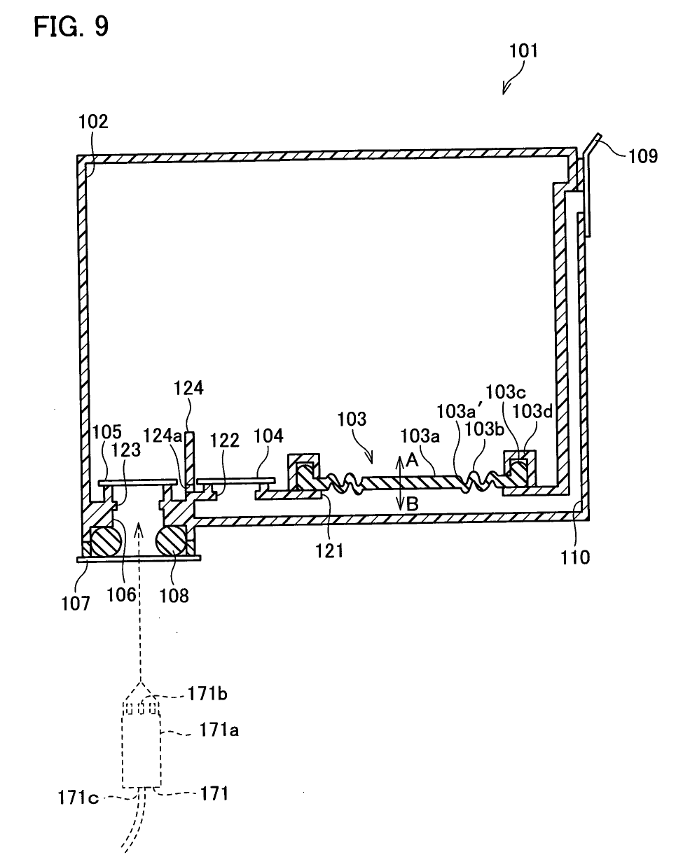

With reference to FIGS. 9 through 14, a third embodiment of the present invention is explained as follows.

FIG. 9 is a sectional view schematically illustrating a structure of an ink supply device according to this embodiment of the present invention. As illustrated in FIG. 9, an ink supply device 101 includes an ink tank 102, a mobile wall (capacity changing means) 103, a first filter (pressure change control means) 104, a second filter (second ink supply means) 105, an ink supply opening 106, a seal film 107, a seal rubber 108, a sealing tape 109, and an air tank 110.

The ink tank 102 is a tank chamber for containing the ink. The ink tank 102 includes a first opening section 121, a second opening section 122, a third opening section 123, and a protective barrier 124. Moreover, the first opening section 121, the second opening section 122, and the third opening section 123 are provided on a bottom surface of the ink tank 102. The protective barrier 124 is later explained.

The mobile wall 103 is provided at the first opening section 121 so as to cover this first opening section. The first filter 104 is provided at the second opening section 122 so as to cover the second opening section 122. Further, the second filter 105 is provided at the third opening section 123 so as to cover the third opening section 123.

The mobile wall 103 includes a wall section 103a, a spring section 103b, an end section 103c, and a fixing section 103d. One end of the spring section 103b is connected to a periphery section 103a′ of the wall section 103a so as to surround the periphery section 103a′. The end section 103c is connected to the other end of the spring 103b. The end section 103c is fixed by the fixing section 103d on the bottom surface of the ink tank 102. Furthermore, the mobile wall 103 is arranged such that the mobile wall 103 does not allow the ink nor the air to pass through the mobile wall 103.

The wall section 103a is arranged to be movable mainly in a direction indicated by an arrow A or an arrow B in FIG. 9, according to this expansion and contraction of the spring section 103b. Therefore, it is possible to change the capacity of the ink tank in the ink supply device 101 by moving the wall section 103a in a direction of the arrow A or the arrow B.

It is preferable that the wall section 103a, the spring section 103b and the end section 103c are formed integrally by using an elastic member such as rubber, in consideration of ink leakage by the ink tank 102 and ease of production.

The first filter 104 is a member for separating the ink tank 102 and the air tank 110. The first filter 104 controls the pressure change, caused by the consumption of ink in the ink tank 102, inside the ink tank 102 by providing air in the air tank 110 to the ink tank 102.

A material, size and the like of this first filter 104 is not specifically limited so long as the meniscus (ink film) can be formed by the ink inside the ink tank 102. For example, a braided metal mesh filter, a filter made of knitted metal fibers or knitted resin fibers, and the like may be used for the first filter 104. A method of knitting the mesh of the first filter 104 also is not specifically limited.

The second filter 105 supplies the ink inside the ink tank 102 to the ink supply opening 106 when the pressure outside the ink tank is equal to or less than a predetermined value. Namely, the second filter passes the ink only when the ink supply opening 106 pulls in the ink. In a case where the ink supply device is replaced by a new device, that is, in a case where the pressure outside the ink tank is equal to or more than the predetermined value, the second supply means does not supply the ink to the outside. This second filter 105 is made of, for example, the same material and shape as the first filter.

The ink supply opening 106 is an opening for supplying the ink supplied from the ink tank 102 to the outside via the second filter 105.

The seal film 107 is a film for blocking the ink supply opening 106. When the ink supply device 101 is attached to a printing device, for example, an ink jet printer (Refer to FIG. 3), this seal film 107 is removed.

The seal rubber 108 is provided so as to be in contact with the ink supply opening 106. Moreover, when the ink supply device 101 is attached to the printing device, the seal rubber 108 contacts a periphery section 171a of the ink supply needle 171 provided to the printing device (Refer to FIG. 9). The seal rubber 108 seals so as to prevent the ink and the air in the ink tank 102 from leaking outside.

The sealing tape 109 is a tape for sealing the air tank 110. This sealing tape 109 as well as the seal film 107 is removed when the ink supply device 101 is attached to the printing device and used.

The air tank 110 is constructed of the mobile wall 103, the first filter 104, a part of a housing of the ink tank 102, and a part of a housing of the ink supply device 101. After the sealing tape 109 is removed, the air tank 110 communicates with the outside. This allows an inflow of air from the outside and an outflow of air to the outside.

The ink supply needle 171 is explained here. When the ink supply device 101 is used, as explained above, the ink supply needle 171 is inserted inside the ink tank 102. The ink supply needle 171 is a hollow needle. One end on an ink tank 102 side of the ink supply needle 171 is pointed. The ink supply needle 171 includes a supply opening 171b near the end on the ink tank 102 side and a supply opening 171c on the other side. The ink contained in the ink tank 102 is supplied to the outside (For example, the ink head and the like in the carriage, when the ink supply device 101 is used for the inkjet printer) of the ink tank 102 via the supply openings 171b and 171c of the ink supply needle 171.

The protective barrier 124 provided inside the ink tank 102 stops air flow so that the air provided inside the ink tank 102 from the first filter 104 is not supplied to an ink head side (not illustrated) together with the ink from the supply opening 171b of the ink supply needle 171 via the second filter 105.

This protective barrier 124 includes an opening 124a, which allows the ink to pass through the opening 124a, at a bottom end of the protective barrier 124. This opening 124a is provided at a position lower than a position at which the first filter 104 and the second filter 105 are provided. Namely, the opening 124a is provided on a bottom surface side of the ink tank 102.

This causes the opening 124a to have a function of keeping the height of the liquid level of the ink inside the ink tank 102 even. Moreover, this can prevent air from being supplied together with the ink through the supply opening 171b of the ink supply needle 171 via this opening 124a, the air having been introduced into inside the ink tank 102 from the first filter 104.

Because the internal pressure of the ink tank 102 is negative, the menisci on the first filter 104 and the second filter 105 are concaved toward the inside of the ink tank 102.

If the ink inside the ink tank 102 is consumed in a case where the ink supply device 101 is attached to a printing device, for example, an inkjet printer and the like, and used, the amount of ink inside the ink tank 102 decreases. The decrease in the amount of the ink in this manner always changes the pressure inside the ink tank 102. Moreover, changes in the external environment of the ink tank 102, for example, a temperature change, pressure change, and the like surrounding the ink tank 102, change a state of the contents inside the ink tank 102. This change in the state of the contents also always changes the internal pressure of the ink tank 102.

The control of the internal pressure in the ink tank 102 of the present invention is explained as follows.

First, an internal pressure control, when the ink supply device 101 is operating (the ink tank is used (the ink is consumed)), is explained. When use of the ink supply device commences, there is a negative pressure inside the ink tank 102.

The negative pressure inside the ink tank 102 increases as the ink inside the ink tank 102 is consumed. When the negative pressure increases up to a predetermined value (critical value), the meniscus formed by the ink on the surface of the first filter 104 breaks.

The ink tank 102, at this time, pulls in air via the first filter 104. This prevents the negative pressure inside the ink tank 102 from becoming excessive. Accordingly, the internal pressure of the ink tank 102 can be controlled within a predetermined range.

Namely, as the ink is consumed, the negative pressure inside the ink tank 102 increases. As a result, the air pushes against the liquid surface of the ink formed on the filter mesh of the first filter 104. The air overcomes the surface tension (breaks the meniscus) and passes through the liquid surface. Then the air becomes an air bubble. The pressure (critical value) for generating this air bubble depends on a fineness of filtration of the first filter (radius of the mesh of the filter). By optimizing the fineness of the filtration, the internal pressure of the ink tank 102, that is, the ink supply pressure, can be kept constant. Moreover, the first filter 104 has a function to remove dust and the like, which is larger than the fineness of the filtration.

In this way, the first filter 104 can control the internal pressure of the ink tank 102 when the ink supply device 101 is operating. Namely, the first filter 104 absorbs the pressure change due to the change (consumption of ink) in the amount of ink remaining inside the ink tank 102.

Namely, the first filter 104 controls the pressure change inside the ink tank 102 by using the surface tension of the ink on a boundary face between the first filter 104 and the ink inside the ink tank 102. This makes it possible to control a change in pressure, due to the consumption of ink, inside the ink tank 102 by a simple structure.

Next, control of the internal pressure due to a temperature change among the external environmental changes is explained.

The temperature surrounding the ink supply device 101 changes according to a change in time, place of installation, and the like. In a case like this, the internal pressure changes because the air inside the ink tank 102 expands or contracts.

Especially, when the consumption of ink proceeds and the air inside the ink tank increases, the change in the internal pressure caused by the temperature change becomes large. Here, assume that, for example, 100 (cc) of air is contained inside the ink tank 102 and constant pressure change occurs. When the temperature inside the ink tank 102 changes from 5° C. to 55° C. under the assumption mentioned above, the air volume becomes 100×(328/278)=118 (cc) according to Boyle-Charle's law. Accordingly, the volume changes by 18 (cc). In other words, the air volume increases by 18 percent. Moreover, the internal pressure of the ink tank 102 becomes 1.18 times under a supposition that a constant volume change and not a constant pressure change occurs.

In this way, when the state of the air changes inside the ink tank 102, the mobile wall 103 changes shape so that the capacity of the ink tank changes according to the change in the state. Namely, when the pressure of the content such as the ink, the air, and/or the like increases, the wall section 103a of the mobile wall 103 moves in a direction of the arrow A as in FIG. 9 so as to increase the capacity of the ink tank 102. When the pressure of the content mentioned above decreases, the wall section 103a of the mobile wall 103 moves in a B direction as in FIG. 9 so as to decrease the capacity of the ink tank 102.

This movement of the mobile wall 103 can control the pressure change inside the ink tank due to the temperature change. Therefore, the ink tank 102 can contain the ink and the air, whose states have changed, without leaking the ink and the air from the first filter 104.

When (i) the air pressure inside the tank=P1 and the volume=V1 at the temperature T1, and (ii) the pressure=P2 and the volume=V2 at the temperature T2, the V2 can be expressed by the following formula:
V2=(P1/P2)·V1·(T2/T1) (2)

Moreover, the capacity changing means is at an equilibrium state before the temperature change. In consideration of this, a straight line Vb is examined. The straight line Vb passes through a point of the volume V1 and the pressure P1, and has an inclination a for the capacity change with respect to the pressure of the capacity changing means. This straight line Vb is expressed by the following formula (3).
Vb=α(P−P1)+V1 (3)

When the volume at the constant pressure change=Vm, Vm is expressed by the following formula (4).
Vm=V1·T2/T1 (4)

Moreover, when the pressure at the constant volume change=Pm, Pm is expressed by the following formula (5).
Pm=P1·T2/T1 (5)

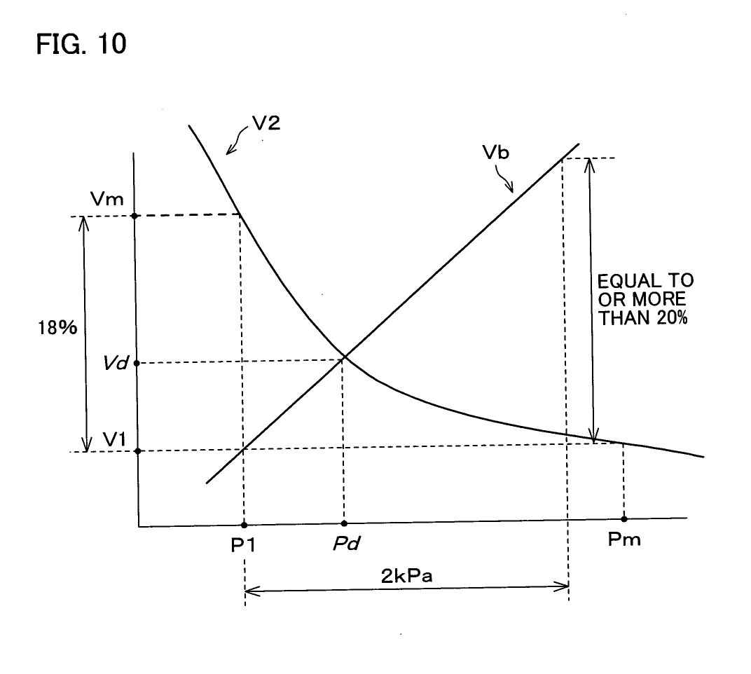

Then, as illustrated in FIG. 10, an intersection (Vd, Pd) of a curve of V2 and a straight line of Vb becomes an operational point.

Namely, this means that the capacity changing means produces an equilibrium at the pressure Pd by changing the capacity by (Vd−V1), whereas the pressure increases up to Pm without a change in volume. A condition of constant operation may be set by the operation point, asolution of a quadratic equation. The detailed explanation of this is omitted.

On the basis of the examination mentioned above, the capacity changing means establishes the setting so that the capacity of the ink tank changes by a manner equal to or more than ten percent with respect to the pressure change per 1 kPa inside the ink tank.

In order to prevent the air from being pulled in mistakenly from the nozzle head for ejecting the ink onto a recording medium such as paper, a maximum value of the ink supply negative pressure is 2 kPa to 3 kPa. Moreover, an upper limit of the ink supply pressure increase is atmospheric pressure, so that the ink does not leak out of a section in communication with the atmosphere (in consideration of vibration and atmospheric pressure change, the upper limit may be set equal to or less than atmospheric pressure.). Accordingly, an acceptable change in the pressure of the ink supply pressure is between substantially 2 kPa to 3 kPa. When the temperature outside the ink tank rises by 50° C. from 5° C. to 55° C., the air volume inside the ink tank increases by substantially 18 percent in case of constant pressure change (Refer to FIG. 10).

Here, in a structure in which the mobile wall 103 is arranged so as to change the capacity of the ink tank 102 by equal to or more than ten percent with respect to a pressure change per 1 kPa inside the ink tank 102, when, for example, the pressure change is 2 kPa, the capacity of the ink tank can be changed by equal to or more than twenty percent (Refer to FIG. 10). Accordingly, when the temperature change is generally equal to or less than 50° C. in an environment in which the ink supply device is used, with this structure, the change of the ink supply pressure can be arranged to be equal to or less than 2 kPa. As a result, highly precise printing can be carried out.

The internal pressure control at the time when the temperature changes is explained above. The internal pressure control at the time when the atmospheric pressure surrounding the ink tank 102 changes is the same as the control for when the temperature changes. In this case also, by the surrounding pressure change, the state of the contents such as the ink, the air, and the like varies inside the ink tank 102. By causing the mobile wall 103 to change the capacity of the ink tank 102, the pressure change inside the ink tank 102 can be controlled. This makes it possible for the ink tank 102 to contain the ink and the air, whose state has changed, without leakage from the first filter 104.

As mentioned above, the ink supply device 101 of the present invention includes the ink tank 102 containing the ink at least inside. The ink supply device 101 also includes the mobile wall (the capacity changing means) 103 and the first filter (the pressure change control means) 104 so as to keep the pressure inside the ink tank 102 at the predetermined value.

The mobile wall (the capacity changing means) 103 changes the capacity of the ink tank 102, according to the change in the state of the contents (the air and the ink) inside the ink tank 102. The change in the state of the contents inside the ink tank 102 is caused by an external environmental change. Moreover, the first filter 104 controls the pressure change, caused by the consumption of ink, inside the ink tank 102 by supplying air to the inside the ink tank 102 from outside of the ink tank 102.

When the head ejects and consumes the ink in a state where the capacity of the mobile wall (the capacity changing means) 103 is in an increased state so as to control the amount of the pressure increase inside the ink tank, the capacity of the mobile wall (the capacity changing means) 103 is caused to decrease along with the consumption of ink and changes so as to restore the capacity to that before the capacity increase. When (i) the supply ability of the mobile wall (the capacity changing means) 103 is exceeded due to the consumption of ink and (ii) the negative pressure inside the ink tank exceeds a pressure predetermined by pressure change control means, the pressure change control function of the first filter (the pressure change control means) 104 is activated.

It becomes possible to keep the internal pressure of the ink tank 102 constant through the mobile wall 103 and the first filter 104. As a result, the ink supply device 101 can supply the ink consistently.

The ink supply device 101 has a structure where only the third opening section 123 (or the second filter 105), and the first filter 104 communicates with the outside of the ink tank 102. Namely, the ink tank 102 is sealed other than through the third opening section 123 (or the second filter 105) and the first filter 104. Accordingly, it is possible to prevent the vaporization of water from the ink inside the ink tank 102 and to solve the problem in that the viscosity of the ink increases.

In the ink supply device 101, the pressure change, caused by the consumption of ink, inside the ink tank 102 is controlled by the first filter 104. In this way, the control of the pressure change, caused by the consumption of ink, inside the ink tank 102 is made possible by a simple structure by using the filter. Further, by selectively using a filter out of filters having different mesh radii, the internal pressure of the ink tank 102 can be controlled easily and precisely.

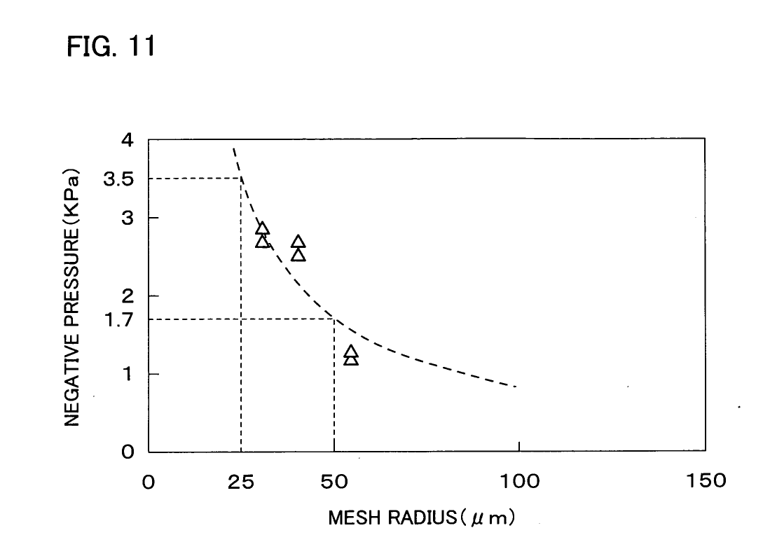

It is preferable that the mesh radius of the filter in the first filter 104 is 25 μm to 50 μm. As illustrated in FIG. 11, by having a 25 μm to 50 μm mesh radius, the negative pressure of the ink tank 102 can have a value between 1.7 kPa and 3.5 kPa. As the result, when there is no pressure change caused by the consumption of ink, inside the ink tank 102, the break of the meniscus formed on the mesh of the first filter 104 can be prevented. Accordingly, ink leakage can be prevented.

Moreover, the second filter 105 is provided to the ink supply device 101. This can prevent ink leakage when the ink supply device is replaced with a new ink supply device.

Further, it is also preferable that the mesh radius of the second filter as well as the mesh radius of the first filter is 25 μm to 50 μm. This makes it possible to make the negative pressure inside the ink tank 102 have a value between 1.7 kPa to 3.5 kPa. As a result, it becomes possible to prevent the meniscus formed on the mesh of the first filter 104 from breaking other than when the ink is supplied. Accordingly, ink leakage can be prevented.

It is preferable that filter surfaces of the first filter 104 and the second filter 105 are respectively caused to be hydrophilic. The hydrophilic filter surfaces are obtained by, for example, a cleaning process.

In this way, by causing the surfaces of each filter to be hydrophilic, the meniscus formed on the filter can be stable.

As illustrated in FIG. 9, the second opening section 122 is provided at the bottom surface of the ink tank 102. Namely, the first filter 104 is provided at the bottom surface of the ink tank 102. As a result, control of the pressure change inside the ink tank 102 can be performed by using the first filter 104 until the ink inside the ink tank 102 is completely consumed.

The third opening section 123 is provided at the bottom surface of the ink tank 102. It is preferable that this third opening section 123 is provided at substantially the same height as the second opening section 122. Namely it is preferable that both of the opening sections 122 and 123 are formed at the same height from the bottom surface of the ink tank 102.

By forming both of the opening sections 122 and 123 in this way, the pressure that the first filter 104 controls near the bottom surface of the ink tank and the pressure near the second filter become substantially same. Therefore, by adjusting the first filter 104, that is, selecting the mesh radius, the ink supply pressure with respect to the outside can be controlled. Accordingly, because there becomes no pressure change from a change in the ink level caused by the consumption of ink, the ink can be supplied consistently to the outside.

In the ink supply device 101, as mentioned above, the first opening section 121 is also provided at the bottom surface of the ink tank 102 in addition to the second opening section 122 and the third opening section 123. This structure allows the mobile wall 103 to be provided at a same surface (bottom surface) as the first filter 104 and the second filter 105 with respect to the ink tank 102. As a result, when the ink supply device 101 is produced, the manufacturing of the ink tank 102 becomes simple.

As illustrated in FIG. 9, in the ink supply device 101, the mobile wall 103 is provided inside the ink supply device 101. This prevents the possibility of user mistakenly touching the mobile wall 103 when, for example, the user replaces the ink supply device 101 with a new device and the like. Namely, application of outside force, which is not intended, on the mobile wall 103 can be prevented. As a result, there is no pressure change, caused by the outside force, inside the ink tank 102. Accordingly, ink leakage can be prevented.

It is preferable that only the ink and the air are contained inside the ink tank 102 of the ink supply device 101. Namely, it is preferable that the ink tank 102 does not contain therein other things such as an absorbent member (for example, a porous body), for example, an ink absorber, an ink pouch, and the like.

This structure makes it possible to utilize the capacity of the ink tank 102 efficiently. In other words, compared with an ink tank including the absorbent member in its structure, an amount of ink that can fill the ink tank 102 is larger because the absorbent member is not contained inside the ink tank 102.

In the ink supply device 101 according to the embodiment of the present invention, the mobile wall 103 is provided at the bottom surface of the ink tank 102. However, the structure is not specifically limited to this. For example, the mobile wall may be provided to an upper surface or a side surface of the ink tank 102.

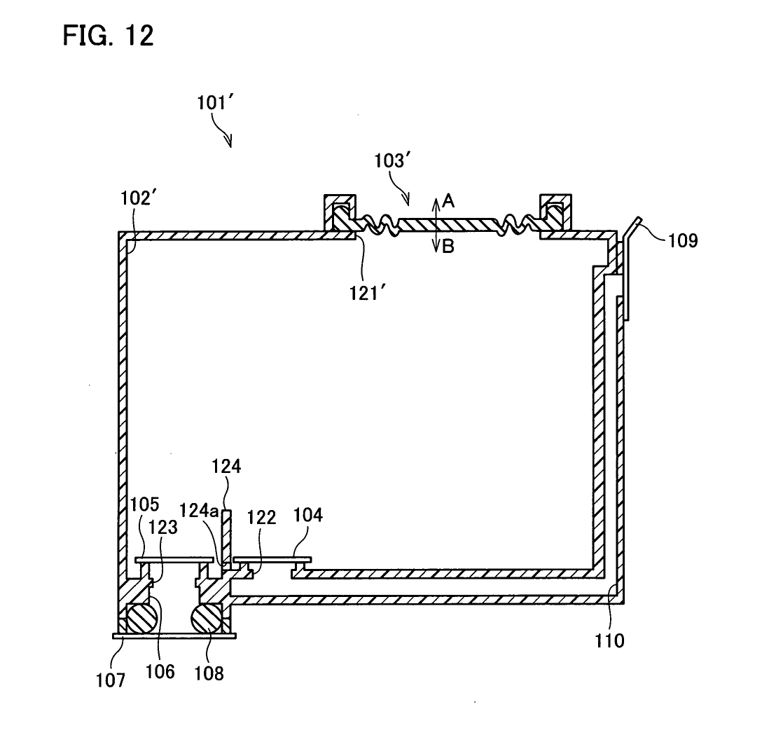

FIG. 12 illustrates a sectional view of the ink supply device in which the mobile wall is provided at an upper surface of the ink tank. For convenience of explanation, the mobile wall is denoted as mobile wall 103′ and the ink supply device including this mobile wall 103′ is denoted as ink supply device 101′. Further, the ink tank of this ink supply device 101′ is denoted as ink tank 102′, and the first opening section is denoted as first opening section 121′.

In the ink supply device 101′, the first opening section 121′ is provided at an upper surface of the ink tank 102′ and the mobile wall 103′ is provided so as to cover this first opening section 121′. Other structures are same as the ink supply device 101.

In this case, the mobile wall 103′ is not influenced by the level change of ink caused by the consumption of ink. Therefore, the pressure change, caused by an external environmental change, inside the ink tank can be controlled more consistently. Because the weight of the ink is not applied on the mobile wall 103′, the influence of a gravitational acceleration (g) in a direction perpendicular with respect to the ink liquid level of the ink tank can be reduced.

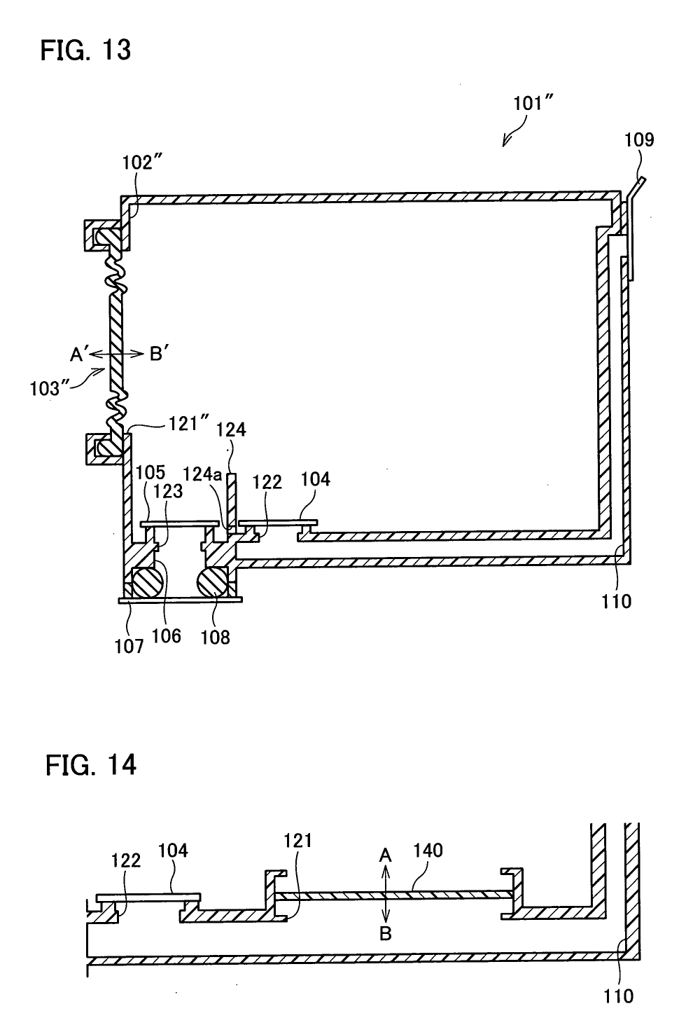

FIG. 13 illustrates a sectional view of the ink supply device in which the mobile wall is provided on the side surface of the ink tank. For convenience of explanation, the mobile wall is denoted as mobile wall 103″ and the ink supply device including this mobile wall 103″ is denoted as the ink supply device 101″. Moreover, the ink tank and the first opening section of this ink supply device 101″ are respectively denoted as ink tank 102″ and first opening section 121″.

In the ink supply device 101″, the first opening section 121″ is provided at a side surface of the ink tank 102″ and the mobile wall 103″ is provided so as to cover this first opening section 121″. Other structures are same as the structure of the ink supply device 101.

Here, it is preferable to provide the mobile wall 103″ so that (i) a direction (A′-B′ direction in FIG. 13) in which the mobile wall 103″ moves so as to change the capacity and (ii) a direction, in which the ink supply device 101″ moves when the ink supply device 101″ is attached to the printing device (not illustrated) and used, differ from each other.

When the direction, in which the capacity changing means moves in order to change the capacity, is parallel to the direction in which the ink supply device moves, the capacity changing means is subjected to the gravitational acceleration (g) in a direction, in which the capacity changing means moves in order to change the capacity, due to the movement accompanied by the acceleration/deceleration of the ink supply device. This causes a pressure change inside the ink tank because an external force is applied to the capacity changing means.

However, by providing the mobile wall 103″ so that the moving direction of the mobile wall 103″ and the moving direction of the ink supply device 101″ differ from each other, the occurrence of the pressure change due to the movement accompanied by the acceleration/deceleration of the ink supply device 101″ can be prevented.

According to the embodiment of the present invention, in order to control the pressure change inside the ink tank, which is caused by the change in the state of the contents inside the ink tank due to an external environmental change, the mobile walls 103, 103′, and 103″ as illustrated in FIG. 9, FIG. 11, and FIG. 12, are provided as the capacity changing means. However, the mobile walls 103, 103′, and 103″ are not limited to the shapes as illustrated.

For example, the mobile wall, as illustrated in FIG. 14, may have a structure that the depth of the first opening section 121 is deep and the cylinder 140 is provided inside the opening. In a structure like this, by the movement of the cylinder 140 in a direction A-B of FIG. 14, the same function as the mobile wall 103 can be attained. Moreover, the mobile wall 103 may be formed by an elastic material such as a balloon rubber. In this case, the structure of the mobile wall 103 can be simplified.

The structures, in which (i) the cylinder is used and (ii) the elastic member such as the balloon rubber is used, may also be applied to a case (Refer to FIG. 12 and FIG. 13) in which the mobile wall is provided at the upper surface or the side surface of the ink tank.

In the ink supply devices 101, 101′ and 101″, the structure, in which (i) the first filter 104 and (ii) the respective mobile walls 103, 103′, and 103″ are included, is illustrated. However, it is possible to have a structure including only the mobile wall 103, 103′, or 103″, or a structure including only the first filter 104.

In the structure including the mobile wall 103, 103′, or 103″ only, the capacity of the ink tank can be changed according to a change in the state of the contents inside the ink tank due to an external environmental change outside the ink tank. Accordingly, it is possible to control the internal pressure change of the ink tank caused by the external environmental change. This makes it possible to keep the internal pressure in the ink tank constant and to supply the ink consistently.

In the structure including only the first filter 104, the pressure change inside the ink tank due to the consumption of ink can be controlled by supplying air to the inside of the ink tank from the outside of the ink tank. Namely, the pressure change inside the ink tank due to the consumption of ink can be controlled by supplying the air into the inside of the ink tank along with the consumption of ink. This makes it possible to keep the internal pressure in the ink tank constant and to supply the ink consistently.

In a case, in which the ink supply device 101, 101′, or 101″ is applied to an inkjet printer, the structure is same as the structure illustrated in FIG. 3. In this case, the ink supply device 101, 101′, or 101″ as illustrated in FIG. 9 is provided to the ink cartridge 14.

As mentioned above, according to the present invention, in an ink supply device, which includes an ink tank for containing ink therein and a tank holder for holding the ink tank in a detachable manner, the tank holder includes pressure control means (for example, a circulation needle, an air supply needle, a pressure control needle, a pressure control tank, and the like) for allowing the ink and air to circulate between the tank holder and the ink tank so that an internal pressure of the attached ink tank has a predetermined value.

Namely, it is preferable that, in the ink supply device, a part (for example, one end of the circulation needle, the air supply needle, or the pressure control needle) of the pressure control means is inserted into the ink tank when the ink tank is attached to the tank holder.

According to the structure above, the tank holder including the pressure control means and the ink tank are arranged to be detachable.

Accordingly, for example, the pressure control means includes a pressure control chamber capable of containing the ink and the air, which circulate between the tank holder and the ink tank. In this case, even when the ink tank is replaced in a state in which (i) the ink inside the ink tank is completely consumed but (ii) there is still ink inside the pressure control chamber of the pressure control means, the ink inside the pressure control chamber can still be utilized with an ink tank attached as a replacement. This makes it possible to efficiently use the ink by eliminating ink wastage.

Moreover, even when the pressure inside the ink tank changes along with (i) consumption of ink and (ii) a change in the surrounding environment (temperature), the pressure control means can control the pressure inside the ink tank through the circulation of the ink and the air. Namely, the pressure change inside the ink tank can be absorbed.

Further, by arranging the pressure control means so as to be detachable with respect to the ink tank, an absorbent material (for example, a porous body), which is for absorbing the pressure change so as to effect a negative pressure inside the ink tank, does not need to be included inside the ink tank.

Ordinarily, when the ink flows inside the absorbent material in the ink tank provided with the absorbent material, the ink is subjected to viscous resistance. In this case, the pressure (ink supply pressure) for ejecting the ink from the ink supply device changes depending on an amount of ink remaining. Namely, pressure loss occurs due to the absorbent material.

However, because the ink tank of the present invention does not include the absorbent material, such pressure change does not occur. Accordingly, the ink can be consistently supplied.

Moreover, it is preferable that, in the ink supply device, the pressure control means includes a pressure control chamber (for example, a control tank, a pressure control tank, and a control chamber) for storing the ink and the air that has flowed out from inside of the ink tank.

According to this structure, the pressure change inside the ink tank due to the change in the surrounding environment (temperature) can be absorbed.

Even when the ink tank is replaced in a state in which (i) the ink inside the ink tank is completely consumed but (ii) there is still ink inside the pressure control chamber, the ink inside the pressure control chamber can still be utilized with an ink tank attached as a replacement. This makes it possible to efficiently use the ink by eliminating ink wastage.

It is preferable that, in the ink supply device, the pressure control means includes air supply means (for example, the air supply needle, the pressure control needle, and the pressure control tank) for supplying the air into the inside of the ink tank from outside.

According to the structure mentioned above, when the ink tank is attached, the ink tank can communicate with the atmosphere. This makes it possible to absorb the pressure change inside the ink tank due to the consumption of ink.

Moreover, the air supply means is included in the tank holder detachable with respect to the ink tank. Accordingly, when the ink tank is detached from the tank holder, the ink tank can be sealed. Therefore, ink leakage from the ink tank can be prevented.

It is preferable that, in the ink supply device, the tank holder includes first ink supply means in communication with the attached ink tank, for supplying the ink contained in the ink tank to outside; and the first ink supply means is caused to be in communication with the ink tank last, when the ink tank is being attached to the tank holder. Namely, the first ink supply means is caused to communicate with the ink tank after the pressure control means is caused to communicate with the ink tank (attached to the ink tank).

For example, assume that the first ink supply means is caused to communicate with the ink tank first. In this case, when the pressure control means is caused to communicate with the ink tank, the pressure inside the ink tank changes. Then, the air and the ink flow out from the first ink supply means.

However, according to the structure mentioned above, when the first ink supply means is attached to the ink tank, the first ink supply means is caused to communicate with the ink tank last. This makes it possible to absorb the pressure change caused by the communication between the pressure control means and the ink tank by the pressure control means. Accordingly, expulsion of the air and the ink into, for example, the ink supply tube (ink supply channel) from the first ink supply means can be prevented. Therefore, when an image is formed by the ink, deterioration of image quality due to discharge of the air and the ink that has been trapped inside the ink supply tube can be prevented.

It is preferable that, in the ink supply device, the tank holder includes first ink supply means in communication with the ink tank attached, for supplying the ink contained in the ink tank to outside; and the first ink supply means has communication with the ink tank disengaged first when the ink tank is detached from the tank holder. Namely, it is before the communication between the pressure control means and the ink is disengaged that the communication between the first ink supply means and the ink tank is disengaged (the first ink supply means is detached form the ink tank).

For example, when communication to the pressure control means is disengaged in a case in which communication to the first ink supply means is disengaged last, a pressure change occurs inside the ink tank. Then, for example, the air is pulled into the ink supply tube (ink supply channel) from the end of the nozzle in a carriage via the first ink supply means.

However, according to the structure mentioned above, by disengaging communication with the first ink supply means first, the pressure change caused by insertion of the first ink supply means can be absorbed by the pressure control means. Accordingly, for example, the situation where the ink supply tube (ink supply channel) pulls in the air can be prevented. Therefore, when the image is formed by the ink, the deterioration of the image quality due to the discharge of air that has been trapped in the ink supply tube can be prevented.

It is preferable that in the ink supply device the ink tank contains therein only the ink and the air.

According to the structure mentioned above, an absorbent material such as an ink absorber and an ink pouch is not contained inside the ink tank. This makes it possible to use the capacity of the ink tank efficiently. Accordingly, reduction in size of the ink tank is possible.

Moreover, it is preferable that, in the ink supply device, the pressure control chamber includes at least a part of a side surface made of a biasing member, which biases another surface (a region (including the side surface) excluding at least the part of the side surface mentioned above, for example, the bottom surface) so that the capacity of the pressure control chamber becomes larger.

According to the structure mentioned above, the pressure change of the ink tank can be absorbed.

It is preferable that, in the ink supply device, the pressure control means is provided near a bottom surface of the ink tank.

According to the structure mentioned above, (i) the pressure (predetermined value), which is controlled by the pressure control means, near the bottom surface of the ink tank and (ii) the pressure of the ink outflow opening (for example, supply opening) of the first ink supply means become substantially same. Accordingly, by control of the pressure control means, control of the ink outflow is possible. Namely, the pressure control means can be used until the ink is completely used.

It is preferable that, in the ink supply device, the pressure control chamber includes an ink absorber which has absorbed the ink beforehand.

According to the structure mentioned above, the negative pressure inside the ink tank can be controlled by including the ink absorber (porous body).

It is preferable that, in the ink supply device, the pressure control means includes negative pressure control means for controlling the internal pressure of the ink tank so as to be negative.

According to the structure mentioned above, the air supply can be controlled with the meniscus by the negative pressure control means (for example, mesh filter). Accordingly, the internal pressure of the ink tank can be controlled to within a predetermined range.

Moreover, it is preferable that, in the ink supply device, capacities Vs and Vt satisfies the following formula:
0.1≦Vs/Vt≦0.3
where Vt is the capacity of the ink tank and Vs is the capacity of the pressure control chamber.

According to the above arrangement, because the pressure control chamber is not filled up, the internal pressure of the ink tank can be kept to within the predetermined range.

According to the present invention, as mentioned above, an ink supply device, which includes an ink tank for containing at least ink therein, includes capacity changing means for changing a capacity of the ink tank, according to a change in a state of a content inside the ink tank due to an environmental change outside the ink tank.

According to the structure, the capacity of the ink tank can be changed by the capacity changing means, according to a change in the state of the content inside the ink tank due to an environmental change outside the ink tank.

Here, when the ink supply device is attached to a printing device such as an inkjet printer and used, the state of the content in the ink tank changes due to the environmental change (for example, temperature change and air pressure change) outside the ink tank. The pressure inside the ink tank always changes due to such changes in the content. Accordingly, in the ink supply device that does not include the capacity changing means, ink leakage occurs when the pressure change inside the ink tank becomes large.

However, as mentioned above, in the present invention, the capacity of the ink tank can be changed by the capacity changing means according to the change in the state of the content. Namely, when, for example, the pressure of the content such as the ink and the air increases due to a surrounding temperature change, the capacity of the ink tank can be increased. When the pressure of the content decreases, the capacity of the ink tank can be decreased. This makes it possible to control a pressure change inside the ink tank caused by the external environmental change.

Accordingly, by the capacity changing means, the internal pressure of the ink tank can be kept constant. Therefore, it becomes possible to provide an ink supply device capable of supplying the ink consistently.

According to the present invention, as mentioned above, an ink supply device, which includes an ink tank for containing at least ink therein, includes pressure change control means for controlling a change in pressure, caused by consumption of the ink, inside the ink tank by supplying air to the inside of the ink tank from outside of the ink tank.

According to the structure mentioned above, the pressure change control means can control the pressure change, caused by the consumption of ink, inside the ink tank by supplying the air to the inside of the ink tank from outside of the ink tank.

When the ink in the ink tank is consumed in a case where the ink supply device is attached to a printing device such as an inkjet printer, the amount of ink in the ink tank decreases. Due to this decrease in the amount of ink, the pressure inside the ink tank always changes. Therefore, in the ink supply device that does not include the pressure change control means, ink leakage occurs when the pressure change inside the ink tank becomes large.

However, in the present invention, as mentioned above, the pressure change control means can control the pressure change, caused by the consumption of ink, inside the ink tank by supplying the air to the inside of the ink tank from the outside of the ink tank. Namely, by supplying the air into the ink tank as the ink is consumed, the pressure change inside the ink tank due to the consumption of ink can be controlled.

Accordingly, by the pressure change control means, the internal pressure of the ink tank can be kept constant. Therefore, it becomes possible to provide an ink supply device capable of supplying the ink consistently.

It is preferable according to the ink supply device of the present invention that the ink supply device, which includes the capacity changing means, further includes pressure change control means for controlling a change in pressure, caused by consumption of the ink, inside the ink tank by supplying air to the inside of the ink tank from outside of the ink tank.

According to the structure mentioned above, the pressure change control means can control the pressure change, due to the consumption of ink, inside the ink tank by supplying the air to the inside of the ink tank from outside of the ink tank.

When the ink in the ink tank is consumed in a case where the ink supply device is attached to a printing device such as an inkjet printer, the amount of ink in the ink tank decreases. Due to this decrease in the amount of ink, the pressure inside the ink tank always changes. Therefore, in the ink supply device that does not include the pressure change control means, ink leakage occurs when the pressure change inside the ink tank becomes large.

However, in the present invention, as mentioned above, the pressure change control means can control the pressure change, caused by the consumption of ink, inside the ink tank by supplying the air to the inside of the ink tank from the outside of the ink tank. Namely, by supplying the air into the ink tank as the ink is consumed, the pressure change inside the ink tank due to the consumption of ink can be controlled.

Accordingly, by the capacity changing means and the pressure change control means, the internal pressure of the ink tank can be kept constant. Therefore, it becomes possible to provide an ink supply device capable of supplying the ink consistently.

It is preferable that, in the ink supply device, the ink tank includes a first opening section and a second opening section; and the capacity changing means and the pressure change control means are provided so as to respectively cover the first opening section and the second opening section.

According to the structure mentioned above, the capacity changing means and the pressure change control means are provided so as to respectively cover the separate opening sections provided to the ink tank.

Accordingly, the capacity changing means is formed by a material, which does not allow the ink to pass through the material but which allows air to pass through the material, for example, a filter, and the like. This makes is possible for the capacity changing means to pass the air into the inside of the ink tank without leaking the ink to the outside of the ink tank.

It is preferable according to the ink supply device of the present invention that, in the ink supply device, the ink tank includes a third opening section for supplying the ink contained in the ink tank to the outside; and only the third opening section and the pressure change control means is in communication with the outside of the ink tank.

According to the above structure, the ink tank is sealed other than at the third opening section for providing the ink outside and the pressure change control means.

Accordingly, the increase in the ink viscosity due to the vaporization of the water from the ink inside the ink tank can be prevented.

It is preferable according to the ink tank of the present invention that, in the ink supply device, the capacity changing means is made of an elastic member.

According to the structure mentioned above, the capacity changing means is made of an elastic material.

Accordingly, it is possible to change the capacity of the ink tank by a simple structure.

It is preferable according to the ink supply device of the present invention that, in the ink supply device, the capacity changing means changes the ink tank capacity by equal to or more than ten percent with respect to a pressure change per 1 kPa inside the ink tank.

According to the above arrangement, the capacity changing means changes the capacity of the ink tank by equal to or more than ten percent with respect to the pressure change per 1 kPa inside the ink tank.

In order to prevent the air from being pulled in mistakenly by the end of the nozzle in the ink head that discharges the ink onto the recording medium such as paper, the maximum value of the ink supply negative pressure is a value between substantially 2 kPa and 3 kPa. In order to avoid ink leakage through the section communicating with the atmosphere, the upper limit of the increase in the ink supply pressure is atmospheric pressure. An acceptable value of the pressure change of the ink supply pressure is between substantially 2 kPa to 3 kPa. Moreover, when the temperature outside the ink tank rises by 50 degrees from 5° C. to 55° C., the volume of the air inside the ink tank increases by substantially 18 percent in a case of constant pressure change.

However, by employing the structure mentioned above, when, for example, the pressure change in the ink tank is 2 kPa, the capacity of the ink tank can be changed by equal to or more than twenty percent.

Accordingly, when the temperature change in the environment, in which the ink supply device is used, is generally equal to or less than 50 degrees, the change of the ink supply pressure can be equal to or less than 2 kPa. Accordingly, highly precise printing on the recording medium becomes possible.

It is preferable according to the ink supply device of the present invention that, in the ink supply device, the capacity changing means is arranged to generate a negative pressure inside the ink tank when the use of the ink supply device starts.

According to the structure above, the capacity changing means is arranged to generate the negative pressure inside the ink tank when the use of the ink supply device starts.

Accordingly, even in a case in which the content inside the ink tank of the ink supply device in use expands due to the external environmental change, the capacity of the ink tank can be assuredly increased.

It is preferable according to the ink supply device of the present invention that, in the ink supply device, the pressure change control means controls the pressure change inside the ink tank by using the surface tension of the ink on a boundary face between the pressure change control means and the ink inside the ink tank.

According to the above arrangement, the pressure change control means controls the pressure change inside the ink tank by using the surface tension of the boundary face between this pressure change control means and the ink inside the ink tank.

Accordingly, the pressure change caused by the consumption of ink inside the ink tank can be controlled by a simple structure.

It is preferable according to the ink supply device of the present invention that, in the ink supply device, the pressure change control means is made of a filter.

According to the structure, the pressure change control means is made of a filter.

Accordingly, the pressure control change means can be provided by a simple structure. Further, by using filters that respectively have mesh radii different from each other selectively, the internal pressure of the ink tank can be controlled easily and precisely.

It is preferable according to the ink supply device of the present invention that, in the ink supply device, a mesh radius of the filter is between 25 μm to 50 μm.

According to the structure, the mesh radius of the filter is between 25 μm and 50 μm.

Accordingly, the pressure (negative pressure) inside the ink tank can be caused to be 1.7 kPa to 3.5 kPa. Therefore, when there is no pressure change inside the ink tank due to the consumption of ink, the breaking of the meniscus formed on the mesh of the filter can be prevented. Accordingly ink leakage can be prevented.

It is preferable according to the ink supply device of the present invention that the ink supply device includes second ink supply means being provided to a third opening section so as to cover the third opening section, the second ink supply means providing the ink to the outside in a case where the pressure outside the ink tank is equal to or less than a predetermined value.

According to the structure mentioned above, the second ink supply means is provided to the third opening section, which is different from the first opening section and the second opening section. The second ink supply means supplies the ink when the pressure outside the ink tank is equal to or less than the predetermined value.

Accordingly, when the ink supply device is replaced by a new device, that is, the pressure outside the ink tank is equal to or more than the predetermined value, the second ink supply means does not supply the ink outside. Therefore, the ink leakage from the third opening section can be prevented.

It is preferable according to the ink supply device of the present invention that, in the ink supply device, the second ink supply means is made of a filter; and the mesh radius of the filter is between 25 μm to 50 μm.

According to the structure, the second ink supply means is made of the filter. The mesh radius of the filter is between 25 μm to 50 μm.

Therefore, the second ink supply means can be provided by a simple structure.

Further, by setting the mesh radius of the filter within the range mentioned above, the pressure (negative pressure) inside the ink tank can be caused to be 1.7 kPa to 3.5 kPa. Therefore, in a case other than that at the time when the ink is supplied, the breaking of the meniscus formed on the mesh of the filter can be prevented. Accordingly, ink leakage can be prevented.

It is preferable according to the ink supply device of the present invention that, in the ink supply device, surfaces of the filter is caused to be hydrophilic.

According to the structure, the surfaces of the filter are caused to be hydrophilic by, for example, the cleaning process.

Accordingly, the meniscus on the filter can be stabilized.

It is preferable according to the ink supply device of the present invention that, in the ink supply device, the capacity changing means is provided so that (i) a direction, in which the capacity changing means moves in order to change the capacity, and (ii) a direction, in which the ink supply device moves when the ink supply device is attached to a printing device and used, differ from each other.

According to the above arrangement, the direction in which the capacity changing means moves in order to change the capacity is not parallel to the direction in which the ink supply device moves when the ink supply device is attached to the printing device and used.

Here, when the direction, in which the capacity changing means moves in order to change the capacity, is parallel to the direction in which the ink supply device moves, the capacity changing means experiences gravitational acceleration (g) in a direction in which the capacity changing means moves so as to change the capacity due to the movement of the ink supply device, the movement being accompanied by acceleration/deceleration. This causes the pressure inside the ink tank to change because outside force is applied to the capacity changing means.

However, the pressure change due to the movement, accompanied by the acceleration/deceleration, of the ink supply device can be prevented by the structure of the present invention.

It is preferable according to the ink supply device of the present invention that, in the ink supply device, the second opening section is provided at a bottom surface of the ink tank.

According to the above structure, the second opening section is provided at the bottom surface of the ink tank. Namely, the pressure change control means is provided at the bottom surface of the ink tank.

Accordingly, the pressure change control using the pressure change control means can be carried out until the ink inside the ink tank is used up.

It is preferable according to the ink supply device of the present invention that, in the ink supply device, the third opening section is provided at a bottom surface of the ink tank; and the second opening section and the third opening section are provided at a substantially same height.

According to the above structure, the pressure change control means and the second ink supply means are provided at the substantially same height. This causes (i) the pressure near the bottom surface of the ink tank that the pressure change control means controls and (ii) the pressure near the second ink supply means to become substantially same.

Accordingly, the control of the pressure change control means makes it possible to control the ink supply pressure. Therefore, because a pressure change due to the change in the level of ink is eliminated, the ink can be supplied to the outside consistently.

It is preferable according to the ink supply device of the present invention that, in the ink supply device, the capacity changing means is provided inside the ink supply device.

According to the above structure, the capacity changing means is provided inside the ink supply device. Therefore, for example, a person and the like cannot touch the capacity changing means easily.

Accordingly, the application of unintended external force to the capacity changing means can be prevented. Therefore, the internal pressure change of the ink tank and the ink leakage resulting from the internal pressure change can be prevented.

It is preferable according to the ink supply device of the present invention that, in the ink supply device, the first opening section is provided at an upper surface of the ink tank.

According to the structure, the first opening section is provided at an upper surface of the ink tank. Namely, the capacity changing means is provided at the upper surface of the ink tank.

Accordingly, the capacity changing means is not influenced by the change of the ink level due to the consumption of ink. Therefore, the pressure change inside the ink tank due to the external environmental change can be controlled more consistently.

Moreover, because the weight of the ink does not affect the capacity changing means, the influence of the gravitational acceleration (g) in the direction perpendicular to the ink liquid level of the ink tank can be reduced.

It is preferable according to the ink supply device of the present invention that, in the ink supply device, the first opening section is provided at a bottom surface of the ink tank.

According to the structure, the first opening section is provided at the bottom surface of the ink tank. Namely, the capacity changing means is provided at the bottom of the ink tank.

According to this, the capacity changing means is provided to the same surface as the pressure change control means, or the same surface as the pressure change control means and the second ink supply means.

Accordingly, when the ink supply device is produced, the production process of the ink tank becomes simple.

It is preferable according to the ink supply device of the present invention that, in the ink supply device, inside the ink tank, only the ink and the air is contained.

According to the above arrangement, the ink absorbent material such as the ink absorber and the ink pouch (for example, porous body) is not contained inside the ink tank. Accordingly, the capacity of the ink tank can be used efficiently.

Therefore, the reduction in the size of the ink tank is possible.

Moreover, when the ink flows inside the ink tank in a general case, in which the absorbent material is provided inside of the ink tank, the ink is subjected to the viscous resistance. In this case, the pressure (ink supply pressure) for pushing the ink outward from the ink supply device changes depending on the amount of ink remaining. Namely, the pressure loss occurs because of the absorbent material.

However, according to the ink supply device of the present invention, because the absorbent material is not provided inside the ink tank in the ink supply device, the pressure loss does not occur. Therefore, the ink can be supplied consistently. This makes it possible to supply the ink consistently especially even in a case when a large amount of the ink needs to be supplied for speed printing and the like.

The invention being thus described, it will be obvious that the invention may be varied in many ways. Such changes are not to be regarded as a departure from the spirit and scope of the invention, and all such modifications as would be obvious to one skilled in the art are intended to be included within the scope of the following claims.

### INDUSTRIAL APPLICABILITY

It is possible to apply the present invention to a copying machine, a facsimile, a word processor, a printer and the like that use an inkjet system.

1. An ink supply device, which includes an ink tank for containing ink therein and a tank holder for holding the ink tank in a detachable manner, wherein
the tank holder includes pressure control means for allowing the ink and air to circulate between the tank holder and the ink tank so that an internal pressure of the attached ink tank has a predetermined value.

2. The ink supply device as set forth in claim 1, wherein
the pressure control means includes a pressure control chamber for storing the ink and the air that has flowed out from inside of the ink tank.

3. The ink supply device as set forth in claim 1, wherein
the pressure control means includes air supply means for supplying the air into the inside of the ink tank from outside.

4. The ink supply device as set forth in claim 1, wherein
a part of the pressure control means is inserted into the ink tank when the ink tank is attached to the tank holder.

5. The ink supply device as set forth in claim 1, wherein:
the tank holder includes first ink supply means in communication with the attached ink tank, for supplying the ink contained in the ink tank to outside; and
the first ink supply means is caused to be in communication with the ink tank last, when the ink tank is being attached to the tank holder.

6. The ink supply device as set forth in claim 1, wherein:
the tank holder includes first ink supply means in communication with the ink tank attached, for supplying the ink contained in the ink tank to outside; and
the first ink supply means has communication with the ink tank disengaged first when the ink tank is detached from the tank holder.

7. The ink supply device as set forth in claim 1 wherein
the ink tank contains therein only the ink and the air.

8. The ink supply device as set forth in claim 2 wherein
the pressure control chamber includes at least a part of a side surface made of a biasing member, which biases another surface so that the capacity of the pressure control chamber becomes larger.

9. The ink supply device as set forth in claim 1 wherein
the pressure control means is provided near a bottom surface of the ink tank.

10. The ink supply device as set forth in claim 2 wherein
the pressure control chamber includes an ink absorber which has absorbed the ink beforehand.

11. The ink supply device as set forth in claim 1 wherein
the pressure control means includes negative pressure control means for controlling the internal pressure of the ink tank so as to be negative.

12. The ink supply device as set forth in claim 2 wherein
capacities Vs and Vt satisfy the following formula:
0.1≦Vs/Vt≦0.3
where Vt is the capacity of the ink tank and Vs is the capacity of the pressure control chamber.

13. An ink supply device, which includes an ink tank for containing at least ink therein, comprising
capacity changing means for changing a capacity of the ink tank, according to a change in a state of a content inside the ink tank due to an environmental change outside the ink tank.

14. An ink supply device, which includes an ink tank for containing at least ink therein, comprising
pressure change control means for controlling a change in pressure, caused by consumption of the ink, inside the ink tank by supplying air to the inside of the ink tank from outside of the ink tank.

15. The ink supply device as set forth in claim 13, comprising
pressure change control means for controlling a change in pressure, caused by consumption of the ink, inside the ink tank by supplying air to the inside of the ink tank from outside of the ink tank.

16. The ink supply device as set forth in claim 15, wherein:
the ink tank includes a first opening section and a second opening section; and
the capacity changing means and the pressure change control means are provided so as to respectively cover the first opening section and the second opening section.

17. The ink supply device as set forth in claim 16 wherein:
the ink tank includes a third opening section for supplying the ink contained in the ink tank to the outside; and
only the third opening section and the pressure change control means is in communication with the outside of the ink tank.

18. The ink supply device as set forth in claim 15, wherein
the capacity changing means is made of an elastic member.

19. The ink supply device as set forth in claim 15, wherein
the capacity changing means changes the ink tank capacity by equal to or more than ten percent with respect to a pressure change per 1 kPa inside the ink tank.

20. The ink supply device as set forth in claim 15, wherein
the capacity changing means is arranged to generate a negative pressure inside the ink tank when the use of the ink supply device starts.

21. The ink supply device as set forth in claim 15, wherein
the pressure change control means controls the pressure change inside the ink tank by using the surface tension of the ink on a boundary face between the pressure change control means and the ink inside the ink tank.

22. The ink supply device as set forth in claim 15, wherein
the pressure change control means is made of a filter.

23. The ink supply device as set forth in claim 22, wherein
a mesh radius of the filter is between 25 μm to 50 μm.

24. The ink supply device as set forth in claim 17, comprising:
second ink supply means being provided to a third opening section so as to cover the third opening section,
the second ink supply means providing the ink to the outside in a case where the pressure outside the ink tank is equal to or less than a predetermined value.

25. The ink supply device as set forth in claim 24 wherein:
the second ink supply means is made of a filter; and
the mesh radius of the filter is between 25 μm to 50 μm.

26. The ink supply device as set forth in claim 22, wherein
surfaces of the filter are caused to be hydrophilic.

27. The ink supply device as set forth in claim 15, wherein
the capacity changing means is provided so that (i) a direction, in which the capacity changing means moves in order to change the capacity, and (ii) a direction, in which the ink supply device moves when the ink supply device is attached to a printing device and used, differ from each other.

28. The ink supply device as set forth in claim 16, wherein
the second opening section is provided at a bottom surface of the ink tank.

29. The ink supply device as set forth in claim 24 wherein:
the third opening section is provided at a bottom surface of the ink tank; and
the second opening section and the third opening section are provided at a substantially same height.

30. The ink supply device as set forth in claim 15, wherein
the capacity changing means is provided inside the ink supply device.

31. The ink supply device as set forth in claim 16, wherein
the first opening section is provided at an upper surface of the ink tank.

32. The ink supply device as set forth in claim 28, wherein
the first opening section is provided at a bottom surface of the ink tank.

33. The ink supply device as set forth in claim 13, wherein
inside the ink tank, only the ink and the air is contained.
